(19) United States
(12) Patent Application Publication
(10) Pub. No.: US 2026/0001291 A1
(43) Pub. Date: Jan. 1, 2026

(54) METHOD OF MANUFACTURING A COATED SPECTACLE LENS COMPRISING STRUCTURES

(71) Applicant: Carl Zeiss Vision International GmbH, Aalen (DE)

(72) Inventors: Yujing Liu, Volertswil (CH); Hamed Sharifi, Waiblingen (DE); Waiz Karim, Ellwangen (DE); Silvia Schmid, Aalen (DE); Robin Schurr, Aalen (DE)

(73) Assignee: Carl Zeiss Vision International GmbH, Aalen (DE)

(21) Appl. No.: 19/270,570

(22) Filed: Jul. 16, 2025

Related U.S. Application Data
(63) Continuation of application No. PCT/EP2024/054181, filed on Feb. 19, 2024.

(30) Foreign Application Priority Data
Feb. 17, 2023 (EP) 23 157 412.0

(51) Int. Cl. B29D 11/00

(52) U.S. Cl. CPC B29D 11/00326; B29D 11/00442; B29D 11/00865; B29D 11/00961

(57) ABSTRACT

A method for designing a digital twin of a coated spectacle lens with a computer for the purpose of a use of the digital twin for manufacturing a coated spectacle lens and a method for manufacturing a coated spectacle lens are provided. The spectacle lens contains a predefined structure or a plurality of predefined structures. The predefined structure or structures are formed by selectively curing the coating composition with a laser beam.

### CROSS REFERENCE TO RELATED APPLICATIONS

This application is a continuation application of international patent application PCT/EP2024/054181, filed Feb. 19, 2024, designating the United States and claiming priority from European patent application EP 23157412.0, filed Feb. 17, 2023, and the entire content of both applications is incorporated herein by reference.

### TECHNICAL FIELD

The present disclosure relates to a method for designing a digital twin of a coated spectacle lens by curing the coating with a laser process and a method for manufacturing such a coated spectacle lens.

### BACKGROUND

WO 2020/180817 A1 discloses a method for exposing an ophthalmic lens at discrete locations to laser radiation to yield in lenslets or light scattering centers. The lenslets can have a diameter of 0.5 mm or more up to 5 mm. The optical power of the lenslets may be zero or they may have an add power of +0.25 D or more up to +5.0 D compared to the base power of the lens. The scattering centers can have a dimension in the x-y plane in a range from about 0.001 mm or more to about 1 mm or less. With reference to FIGS. 3A to 3D, a layer of a sacrificial material is deposited on a lens surface in a thickness sufficiently thin to be readily removed by exposure to laser radiation, thereby forming pits in the lens surface. A deposit material fills the pits and may form a layer on the remaining sacrificial material. The filled pits can provide a light scattering effect, a lensing effect or reduce light transmission. Finally, the deposit material remaining on the layer of sacrificial material is removed from the lens surface. With reference to FIGS. 5A to 5C, laser radiation is used to locally reshape a material deposited on a lens surface into lenslets, for example by locally melting the material. The remaining material may be removed, leaving behind the lenslets only. With reference to FIGS. 6A to 6C, laser radiation is used to form a lenslet in a lens surface by locally melting a portion of the lens surface and reshaping that portion to a lenslet.

WO 2022/251713 A1 discloses a method for forming optical elements on a surface of an ophthalmic lens using a different absorption of a same laser radiation wavelength. With reference to FIGS. 1A to 1C, a laser radiation locally absorbed by a laser interaction layer on a surface of a lens substrate forms discrete optical elements at the surface of the lens substrate, for example, by melting the laser interaction layer where exposed. With reference to FIG. 4, a laser interaction layer applied to a lens surface facilitates formation of optical elements in the bulk material of the lens substrate at the surface thereof without changing the surface shape, for example, by locally heating the bulk material of the lens substrate to a temperature at which an index of refraction of the bulk material changes to form an optical element. With reference to FIG. 5, a laser interaction layer alternatively may be incorporated into the bulk material of the lens substrate at the lens surface.

WO 2021/236687 A2 discloses a method for forming optical elements on an ophthalmic lens according to a pattern. Material can be deposited on a surface of the lens to form the optical elements, or the lens can be exposed to radiation which modifies the surface and/or bulk of the lens to form the optical elements. Additional coatings can be applied to one or both surface either before or after the application of the pattern. The optical elements can be formed on the lens by UV LED Direct-to-Substrate Printing, pad printing, hot stamping, screen printing, transfer or lithographic printing.

WO 2020/261213 A1 discloses an ophthalmic lens comprising a base lens and one or more light modulating cell zones comprising a plurality of light modulating cells. A light modulating cell may be generated by a laser in a subtractive or localized lens material change process.

US 2017/0131567 A1 discloses a spectacle lens having a first refraction area based on a prescription of correcting the refraction of an eye and second refraction areas having a refractive power different from the first refractive power and having a function of focusing an image on a position other than a retina of the eye. The second refraction areas are formed as a plurality of island-shaped areas on a surface of a spectacle lens, arranged as shown in FIG. 1 or FIG. 10, as hexagon within a circular area of a radius of 20 mm or less with an optical center as a center of the spectacle lens. In FIG. 1, the island-shaped areas are not arranged in a circular area of a radius of 2.5 to 10.0 mm with the optical center as the center of the spectacle lens. An island-shaped area has a refractive power larger than the refractive power of the first refraction area by 2.00 D to 5.00 D. Each surface of the island-shaped areas has an area of about 0.50 to 3.14 mm² and has a circular shape of a diameter of about 0.8 to 2.0 mm. The island-shaped areas are separated from each other by a distance almost equal to a value of a radius of diameter/2.

WO 2019/166659 A1 discloses a spectacle lens comprising a plurality of contiguous optical elements, arranged as shown in FIG. 1, FIG. 10 or FIG. 12. The optical elements have a contour shape being inscribable in a circle having a diameter greater than or equal to 0.8 mm and smaller than or equal to 3.0 mm. The contiguous optical elements arranged in at least two concentric rings have a same center. The distance between two concentric rings of contiguous optical elements varies between 2.0 mm and 5.0 mm. In an annular zone of the spectacle lens having an inner diameter greater than 9 mm and an outer diameter smaller than 57 mm, the ratio between the sum of areas of the contiguous optical elements located inside the zone and the area of the zone is comprised between 20% and 70%. The contiguous optical elements are made by direct surfacing, molding, casting or injection, embossing, filming, or photolithography.

WO 2019/166659 A1 further discloses a spectacle lens comprising concentric rings, arranged as shown in FIG. 11b and described on page 20, lines 10 to 12.

CN 111103701 A discloses a spectacle lens comprising an annular cylindrical microstructure, arranged as shown in FIG. 1. The central optical area is circular having a radius of 5 mm to 10 mm, the center of the spectacle lens being the center of the circle. The annular cylindrical microstructure is located outside the central optical area having a radius between the one of the central optical area and 20 mm or more. The radial width of the annular cylindrical microstructures is 0.5 mm to 2 mm. The distance between the different cylindrical microstructure is 0.5 mm to 3 mm. The annular cylindrical microstructure is made by injection molding.

WO 2023/155984 discloses a spectacle lens comprising ring-shaped focusing structures surrounding a central clear zone having a central clear zone width of 6 mm to 9.4 mm. The ring-shaped focusing structures have a width of equal to or lower than 0.7 mm.

### SUMMARY

Based on WO 2020/180817 A1 the problem underlying the present disclosure is to provide a method for selectively structuring a surface of a spectacle lens without a need of a masking layer of sacrificial material or locally melting either a deposited material or a lens material.

Based on WO 2021/236687 A2, in particular page 15, lines 28 to 30, disclosing that optical elements are formed by inkjetting a curable material onto a surface of a blank ophthalmic lens and then curing the material to set the optical elements in the pattern and FIG. 2, the problem underlying the present disclosure is to provide a method for selectively structuring a surface of a spectacle lens without a need of inkjetting the curable material only in a position to set the optical elements in the pattern.

In particular, the problem underlying the present disclosure is to provide: an alternative method for manufacturing a spectacle lens comprising lenslets arranged as described in WO 2020/180817 A1, and for example shown in FIGS. 12B, 14, or 15 thereof, having the dimensions and the optical power as disclosed therein; an alternative method for manufacturing a spectacle lens comprising discrete optical elements arranged and having desired dimensions as described in WO 2022/251713A1; an alternative method for manufacturing a spectacle lens comprising lenslets having the add power and the size as described in WO 2021/236687 A2; an alternative method for manufacturing a spectacle lens comprising a plurality of light modulating cells arranged as described in WO 2020/261213 A1, and for example shown in FIGS. 6a to 6l, 16 to 19, 22 to 34, 39 to 41, or 43 to 45 thereof, having the dimensions and power as disclosed therein; a concrete method for manufacturing a spectacle lens comprising a plurality of island-shaped areas arranged as described in US 2017/0131567 A1, and for example shown in FIGS. 1 and 10 thereof, having the dimensions disclosed therein; an alternative method for manufacturing a spectacle lens comprising contiguous optical elements arranged as described in WO 2019/166659 A1, and for example shown in FIG. 1, 10 or 12 thereof, having the dimensions disclosed therein; an alternative method for manufacturing a spectacle lens comprising concentric rings arranged as described in WO 2019/166659 A1, and for example shown in FIG. 11 thereof; an alternative method for manufacturing a spectacle lens comprising an annular cylindrical microstructure arranged as described in CN 111103701 A, and for example shown in FIG. 1 thereof, having the dimensions disclosed therein; or a concrete method for manufacturing a spectacle lens comprising ring-shaped focusing structures arranged as described in WO 2023/155984 A1, and for example shown in FIG. 1, 7, 8, 9, or 10 thereof, having the dimension disclosed therein.

The problem has been solved by the methods according to the exemplary embodiments disclosed herein.

The method according to the disclosure is configured for designing a digital twin of a coated spectacle lens by means of a computer for the purpose of a use of the digital twin for manufacturing the coated spectacle lens, the digital twin comprising (i) one predefined structure or (ii) a plurality of predefined structures, and comprises the step of
determining laser process parameters based on curing characteristics of a coating composition to achieve (i) the one predefined structure or (ii) the plurality of predefined structures.

Typically, the method is configured for designing a digital twin of a coated spectacle lens by means of a computer for the purpose of a use of the digital twin for manufacturing the coated spectacle lens, the digital twin comprising (i) one predefined structure or (ii) a plurality of predefined structures, and comprises the step of
determining laser process parameters based on curing characteristics of a coating composition to achieve a coated spectacle lens comprising (i) one structure corresponding to the one predefined structure or (ii) a plurality of structures corresponding to the plurality of predefined structures.

### BRIEF DESCRIPTION OF THE DRAWINGS

The disclosure will now be described with reference to the drawings wherein:

FIG. 1 schematically shows different structures obtained by a selectively curing and overcoating;

FIG. 2 shows surface profiles of coated spectacle lenses before the application and curing of the hard coating;

FIG. 3 shows surface profiles of coated spectacle lenses with a hard coating surface layer;

FIG. 4 shows the simulated surface power of the structures of FIG. 3;

FIG. 5 shows the surface profiles of coated spectacle lenses;

FIG. 6 shows further surface profiles of coated spectacle lenses; and

FIG. 7 shows the simulated surface power of coated spectacle lenses.

### DESCRIPTION OF EXEMPLARY EMBODIMENTS

A “digital twin of a coated spectacle lens” shall be defined analogously as in ISO 13666:2019(E), section 3.18.1 (coated lens), as a digital twin of a spectacle lens to which one surface layer or more surface layers have been added digitally to alter one property or more properties of the digital twin of the spectacle lens. The digital twin of the coated spectacle lens is for the purpose of a use of the digital twin for manufacturing the coated spectacle lens. The digital twin of the coated spectacle lens is a mathematical description of a lens surface of a front surface of the coated spectacle lens, i.e., the mathematical description of the front surface of the coated spectacle lens, a mathematical description of a lens surface of a back surface of the coated spectacle lens, i.e., the mathematical description of the back surface of the coated spectacle lens, the mathematical descriptions including a relative orientation of the lens surface of the front surface to the lens surface of the back surface, i.e., the mathematical descriptions including the relative orientation of the front surface to the back surface, and a refractive index of a digital twin of a spectacle lens. The mathematical descriptions typically are including the refractive index of the digital twin of the spectacle lens only. A refractive index of one surface layer or each surface layer of more surface layers digitally added to the digital twin of the spectacle lens typically is assumed to be identical to the refractive index of the digital twin of the spectacle lens. The refractive index of the digital twin of the spectacle lens typically is a uniform refractive index.

The front surface of the digital twin of the coated spectacle lens typically comprises (i) one structure or (ii) a plurality of structures. The back surface of the digital twin of the coated spectacle lens optionally comprises (i) one structure or (ii) a plurality of structures. The front surface of the digital twin of the coated spectacle lens is defined analogously as in ISO 13666:2019(E), section 3.2.13, as a surface which when the digital twin is transferred to the coated spectacle lens is intended to be fitted away from the eye. The back surface of the digital twin of the coated spectacle lens is defined analogously as in ISO 13666:2019(E), section 3.2.14, as a surface which when the digital twin is transferred to the coated spectacle lens is intended to be fitted nearer to the eye. The digital twin is transferred to the coated spectacle lens, i.e., the digital twin is transferred to physical reality, by manufacturing the coated spectacle lens, as described in detail below.

The digital twin of the coated spectacle lens is a mathematical description or a mathematical representation of the lens surfaces of the coated spectacle lens including a relative orientation of the lens surfaces to each other and the refractive index of the digital twin of the spectacle lens, the mathematical description or the mathematical representation being computer-readable data or in the form of computer-readable data, the computer-readable data being for the purpose of a use for manufacturing the coated spectacle lens. The computer-readable data may (i) be stored on a computer-readable storage medium, (ii) embodied in a data signal or (iii) transferred via a data signal. The computer-readable storage medium may be a non-transitory tangible computer-readable storage medium. The computer-readable data may additionally contain manufacturing instructions for transferring the digital twin of the coated spectacle lens to physical reality, i.e., for manufacturing the coated spectacle lens.

The digital twin of the coated spectacle lens may, for the purpose of a use of the digital twin for manufacturing the coated spectacle lens, additionally or alternatively, be one of the following:
an analytical description or an analytical model describing or representing the coated spectacle lens. The analytical description or the analytical model is for the purpose of a use for manufacturing the coated spectacle lens. The analytical description or the analytical model typically is a piecewise representation and comprises (a) a mathematical formula describing a lens surface of a front surface of the coated spectacle lens, i.e., the mathematical formula describing the front surface of the coated spectacle lens, typically the mathematical formula describing the lens surface of the front surface not considering the (i) one structure or the (ii) plurality of structures; (b) a mathematical formula describing a lens surface of a back surface of the coated spectacle lens, i.e., the mathematical formula describing the back surface of the coated spectacle lens, typically the mathematical formula describing the lens surface of the back surface not considering the (i) one structure or the (ii) plurality of structures; (c) (i) a piecewise mathematical formula describing the one structure, in particular a surface, typically as could be seen in the examples given below in the sense of surface shape, form or topography, a position and a domain of the one structure or (c) (ii) piecewise mathematical formulas describing each structure of the plurality of structures, in particular a surface, typically as could be seen in the examples given below in the sense of surface shape, form or topography, a position and a domain of each structure of the plurality of structures; (d) a mathematical formula describing a relative orientation of the lens surface of the front surface to the lens surface of the back surface, i.e., the mathematical formula describing the relative orientation of the front surface to the back surface; and (e) a mathematical formula describing a refractive index of a digital twin of a spectacle lens. Alternatively, the analytical description or the analytical model is a piecewise representation and comprises (a) a mathematical formula or mathematical formulas describing a lens surface of the front surface considering optionally the (i) one structure or (ii) each structure of the plurality of structures, typically the mathematical formula(s) describing the lens surface of the front surface inclusive the (i) one structure or (ii) each structure of the plurality of structures; (b) a mathematical formula or mathematical formulas describing a lens surface of a back surface considering optionally the (i) one structure or (ii) each structure of the plurality of structures, typically the mathematical formula describing the lens surface of the back surface; (c) a mathematical formula describing the relative orientation of the lens surface of the front surface to the lens surface of the back surface; and (d) a mathematical formula describing the refractive index of the digital twin of the spectacle lens;
an analytical description or an analytical model describing or representing the coated spectacle lens, the analytical description or the analytical model additionally containing manufacturing instructions, typically manufacturing instructions considering laser process parameters to achieve the (i) one predefined structure or the (ii) plurality of predefined structures;
in the form of an analytical description or an analytical model representing the coated spectacle lens, the analytical description or the analytical model being for the purpose of a use for manufacturing the coated spectacle lens;
in the form of an analytical description or an analytical model representing the coated spectacle lens, the analytical description or the analytical model additionally containing manufacturing instructions, typically manufacturing instructions considering laser process parameters to achieve the (i) one predefined structure or the (ii) plurality of predefined structures;
the analytical description or the analytical model being (i) computer-readable data or (ii) in the form of computer-readable data, the computer-readable data being for the purpose of a use for manufacturing the coated spectacle lens;
the analytical description or the analytical model being (i) computer-readable data or (ii) in the form of computer-readable data, the computer-readable data additionally containing manufacturing instructions, typically manufacturing instructions considering laser process parameters to achieve the (i) one predefined structure or the (ii) plurality of predefined structures;
the analytical description or the analytical model being for the purpose of a use for manufacturing the coated spectacle lens and being (i) stored on a computer-readable storage medium, (ii) embodied in a data signal or (iii) transferred via a data signal. The computer-readable storage medium may be a non-transitory tangible computer-readable storage medium;
numerical data describing or representing the coated spectacle lens. The numerical data are for the purpose of a use for manufacturing the coated spectacle lens. The numerical data typically are comprising or being a conversion of the analytical description or the analytical model. The numerical data typically comprises discrete x,y,z positions of or on the front surface of the digital twin of the coated spectacle lens and discrete x,y,z positions of or on the back surface of the digital twin of the coated spectacle lens. A pattern comprising discrete x,y positions may be adapted or selected arbitrarily. Typically, the pattern comprising discrete x,y positions is adapted or selected to consider a beam diameter as defined in ISO 11145:2018(E), section 3.3, in particular a beam diameter dᵤ(z) as defined in ISO 11145:2018(E), section 3.3.1, of a laser. The numerical data comprises the function value z of the analytical description or the analytical model of a respective lens surface in each of the discrete x,y positions. A relative orientation of discrete x,y positions of the lens surface of the front surface, i.e., discrete x,y positions of the front surface, and discrete x,y positions of the lens surface of the back surface, i.e., discrete x,y positions of the back surface, to each other is comprised in the numerical data. The function value z in each discrete x,y position, i.e., the discrete x,y,z positions, of the front and back surface are described in the same coordinate system or a relative orientation of the coordinate systems of the front surface and the back surface is comprised in the numerical data. A refractive index of the digital twin of the spectacle lens is comprised in the numerical data;
numerical data describing or representing the coated spectacle lens, the numerical data additionally containing manufacturing instructions, typically manufacturing instructions considering laser process parameters to achieve the (i) one predefined structure or the (ii) plurality of predefined structures;
in the form of numerical data describing or representing the coated spectacle lens, the numerical data being for the purpose of a use for manufacturing the coated spectacle lens;
in the form of numerical data describing or representing the coated spectacle lens, the numerical data additionally containing manufacturing instructions, typically manufacturing instructions considering laser process parameters to achieve the (i) one predefined structure or the (ii) plurality of predefined structures;
the numerical data being (i) computer-readable data or (ii) in the form of computer-readable data, the computer-readable data being for the purpose of a use for manufacturing the coated spectacle lens;
the numerical data being (i) computer-readable data or (ii) in the form of computer-readable data, the computer-readable data additionally containing manufacturing instructions, typically manufacturing instructions considering laser process parameters to achieve the (i) one predefined structure or the (ii) plurality of predefined structures;
the numerical data being for the purpose of a use for manufacturing the coated spectacle lens and being (i) stored on a computer-readable storage medium, (ii) embodied in a data signal or (iii) transferred via a data signal. The computer-readable storage medium may be a non-transitory tangible computer-readable storage medium;
computer-readable data describing or representing the coated spectacle lens, the computer-readable data being for the purpose of a use for manufacturing the coated spectacle lens;
computer-readable data describing or representing the coated spectacle lens, the computer-readable data additionally containing manufacturing instructions, typically manufacturing instructions considering laser process parameters to achieve the (i) one predefined structure or the (ii) plurality of predefined structures;
in the form of computer-readable data describing or representing the coated spectacle lens, the computer-readable data being for the purpose of a use for manufacturing the coated spectacle lens;
in the form of computer-readable data describing or representing the coated spectacle lens, the computer-readable data additionally containing manufacturing instructions, typically manufacturing instructions considering laser process parameters to achieve the (i) one predefined structure or the (ii) plurality of predefined structures;
the computer-readable data being for the purpose of a use for manufacturing the coated spectacle lens and being (i) stored on a computer-readable storage medium, (ii) embodied in a data signal or (iii) transferred via a data signal. The computer-readable storage medium may be a non-transitory tangible computer-readable storage medium;
a virtual representation of the coated spectacle lens, the virtual representation being for the purpose of a use for manufacturing the coated spectacle lens;
a virtual representation of the coated spectacle lens in the form of computer-readable data, the computer-readable data being for the purpose of a use for manufacturing the coated spectacle lens;
a virtual representation of the coated spectacle lens in the form of computer-readable data, the computer-readable data additionally containing manufacturing instructions, typically manufacturing instructions considering laser process parameters to achieve the (i) one predefined structure or the (ii) plurality of predefined structures;
the virtual representation of the coated spectacle lens being for the purpose of a use for manufacturing the coated spectacle lens and being (i) stored on a computer-readable storage medium, (ii) embodied in a data signal or (iii) transferred via a data signal. The computer-readable storage medium may be a non-transitory tangible computer-readable storage medium;
the virtual representation of the coated spectacle lens in the form of computer-readable data, the computer-readable data being for the purpose of a use for manufacturing the coated spectacle lens and being (i) stored on a computer-readable storage medium, (ii) embodied in a data signal or (iii) transferred via a data signal. The computer-readable storage medium may be a non-transitory tangible computer-readable storage medium.

A “coated spectacle lens” results from a transfer of a digital twin of a coated spectacle lens to physical reality. The digital twin of the coated spectacle lens is transferred to physical reality by manufacturing the coated spectacle lens. The coated spectacle lens is defined as in ISO 13666:2019(E), section 3.18.1 (coated lens), as a spectacle lens (3.5.2) to which one surface layer or more surface layers has/have been added to alter one property or more properties of the spectacle lens. A spectacle lens is as defined in ISO 13666:2019(E), section 3.5.2, an ophthalmic lens (3.5.1) worn in front of, but not in contact with, the eyeball. A front surface of the coated spectacle lens shall be defined analogously as in ISO 13666:2019(E), section 3.2.13, as surface of the coated spectacle lens intended to be fitted away from the eye. A back surface of a coated spectacle lens shall be defined analogously as in ISO 13666:2019(E), section 3.2.14, as surface of the coated spectacle lens intended to be fitted nearer to the eye.

A “digital twin of a spectacle lens” shall be defined analogously as in ISO 13666:2019(E), section 3.5.2 (spectacle lens), as a digital twin of an ophthalmic lens worn, when transferred to physical reality, in front of, but not in contact with, the eyeball. The digital twin of the spectacle lens is for the purpose of a use of the digital twin for manufacturing the spectacle lens. The digital twin of a spectacle lens is a mathematical description of a front surface of the spectacle lens, a mathematical description of a back surface of the spectacle lens, the mathematical descriptions including a relative orientation of the front surface and the back surface and a refractive index of an optical material between the front surface and the back surface. A front surface of the digital twin of the spectacle lens is defined analogously as in ISO 13666:2019(E), section 3.2.13, as a surface which when the digital twin is transferred to physical reality is intended to be fitted away from the eye. A back surface of the digital twin of the spectacle lens is defined analogously as in ISO 13666:2019(E), section 3.2.14, as a surface which when the digital twin is transferred to physical reality is intended to be fitted nearer to the eye. The digital twin of the spectacle lens is transferred to physical reality by manufacturing the spectacle lens. The refractive index of the optical material included in the mathematical descriptions typically is a uniform refractive index. The refractive index of the optical material included in the mathematical descriptions typically is the refractive index the spectacle lens has when the digital twin of the spectacle lens has been transferred to physical reality.

The digital twin of the spectacle lens may, for the purpose of a use of the digital twin for manufacturing the spectacle lens and, after addition of one surface layer or more surface layers, the coated spectacle lens, additionally or alternatively, be one of the following: - an analytical description or an analytical model describing or representing the spectacle lens. The analytical description or the analytical model is for the purpose of a use for manufacturing the spectacle lens. The analytical description or the analytical model typically is a piecewise representation and comprises (a) a mathematical formula describing a lens surface of a front surface of the spectacle lens, i.e., the mathematical formula describing the front surface of the spectacle lens, (b) a mathematical formula describing a lens surface of a back surface of the spectacle lens, i.e., the mathematical formula describing the back surface of the spectacle lens, and (c) a mathematical formula describing a refractive index of an optical material;
an analytical description or an analytical model describing or representing the spectacle lens, the analytical description or the analytical model additionally containing manufacturing instructions, typically for obtaining final optical surfaces of the spectacle lens;
in the form of an analytical description or an analytical model representing the spectacle lens, the analytical description or the analytical model being for the purpose of a use for manufacturing the spectacle lens;
in the form of an analytical description or an analytical model representing the spectacle lens, the analytical description or the analytical model additionally containing manufacturing instructions, typically for obtaining final optical surfaces of the spectacle lens;
the analytical description or the analytical model being (i) computer-readable data or (ii) in the form of computer-readable data, the computer-readable data being for the purpose of a use for manufacturing the spectacle lens;
the analytical description or the analytical model being (i) computer-readable data or (ii) in the form of computer-readable data, the computer-readable data additionally containing manufacturing instructions, typically for obtaining final optical surfaces;
the analytical description or the analytical model being for the purpose of a use for manufacturing the spectacle lens and being (i) stored on a computer-readable storage medium, (ii) embodied in a data signal or (iii) transferred via a data signal. The computer readable storage medium may be a non-transitory tangible computer-readable storage medium;
numerical data describing or representing the spectacle lens. The numerical data are for the purpose of a use for manufacturing the spectacle lens. The numerical data typically are comprising or being a conversion of the analytical description or the analytical model. The numerical data typically comprises a) discrete x,y,z positions of or on a front surface of the spectacle lens and b) discrete x,y,z positions of or on a back surface of the spectacle lens. A pattern comprising discrete x,y positions may be adapted or selected arbitrarily. The numerical data comprises the function value z of the analytical description or the analytical model of the lens surface in each of the discrete x,y positions. The function value z in each discrete x,y position, i.e., the discrete x,y,z positions, of the front and back surface are described in the same coordinate system or a relative orientation of the coordinate systems of the lens front surface and the lens back surface is comprised in the numerical data. A refractive index of an optical material is comprised in the numerical data;
numerical data describing or representing the spectacle lens, the numerical data additionally containing manufacturing instructions, typically for obtaining final optical surfaces of the spectacle lens;
in the form of numerical data describing or representing the spectacle lens, the numerical data being for the purpose of a use for manufacturing the spectacle lens;
in the form of numerical data describing or representing the spectacle lens, the numerical data additionally containing manufacturing instructions, typically for obtaining final optical surfaces of the spectacle lens;
the numerical data being (i) computer-readable data or (ii) in the form of computer-readable data, the computer-readable data being for the purpose of a use for manufacturing the spectacle lens;
the numerical data being (i) computer-readable data or (ii) in the form of computer-readable data, the computer-readable data additionally containing manufacturing instructions, typically for obtaining final optical surfaces of the spectacle lens;
the numerical data being for the purpose of a use for manufacturing the coated spectacle lens and being (i) stored on a computer-readable storage medium, (ii) embodied in a data signal or (iii) transferred via a data signal. The computer-readable storage medium may be a non-transitory tangible computer-readable storage medium;
computer-readable data describing or representing the spectacle lens, the computer-readable data being for the purpose of a use for manufacturing the spectacle lens;
computer-readable data describing or representing the spectacle lens, the computer-readable data additionally containing manufacturing instructions, typically for obtaining final optical surfaces of the spectacle lens;
in the form of computer-readable data describing or representing the spectacle lens, the computer-readable data being for the purpose of a use for manufacturing the spectacle lens;
in the form of computer-readable data describing or representing the spectacle lens, the computer-readable data additionally containing manufacturing instructions, typically for obtaining final optical surfaces of the spectacle lens;
the computer-readable data being for the purpose of a use for manufacturing the spectacle lens and being (i) stored on a computer-readable storage medium, (ii) embodied in a data signal or (iii) transferred via a data signal. The computer-readable storage medium may be a non-transitory tangible computer-readable storage medium;
a virtual representation of the spectacle lens, the virtual representation being for the purpose of a use for manufacturing the spectacle lens;
a virtual representation of the spectacle lens in the form of computer-readable data being for the purpose of a use for manufacturing the spectacle lens;
a virtual representation of the spectacle lens in the form of computer-readable data, the computer-readable data additionally containing manufacturing instructions, typically for obtaining final optical surfaces of the spectacle lens;
the virtual representation of the spectacle lens being for the purpose of a use for manufacturing the spectacle lens and being (i) stored on a computer-readable storage medium, (ii) embodied in a data signal or (iii) transferred via a data signal. The computer-readable storage medium may be a non-transitory tangible computer-readable storage medium;
the virtual representation of the spectacle lens in the form of computer-readable data being for the purpose of manufacturing the spectacle lens and being (i) stored on a computer-readable storage medium, (ii) embodied in a data signal or (iii) transferred via a data signal. The computer-readable storage medium may be a non-transitory tangible computer-readable storage medium.

A “spectacle lens” results from a transfer of a digital twin of a spectacle lens to physical reality. The digital twin of the spectacle lens is transferred to physical reality by manufacturing the spectacle lens. The spectacle lens is as defined in ISO 13666:2019(E), section 3.5.2, an ophthalmic lens (3.5.1) worn in front of, but not in contact with, the eyeball. A front surface of the spectacle lens is defined as in ISO 13666:2019(E), section 3.2.13, as surface of the spectacle lens intended to be fitted away from the eye. A back surface of the spectacle lens is defined as in ISO 13666:2019(E), section 3.2.14, as surface of the spectacle lens intended to be fitted nearer to the eye.

The spectacle lens typically is a finished spectacle lens, the finished spectacle lens as defined in ISO 13666:2019(E), section 3.8.7 (finished lens), as lens (3.5.2) of which both sides have their final optical surface. The finished spectacle lens may be either an uncut spectacle lens as defined in ISO 13666:2019(E), section 3.8.8 (uncut lens) or an edged spectacle lens as defined in ISO 13666:2019(E), section 3.8.9 (edged lens). The spectacle lens typically is selected from at least one of
a single-vision spectacle lens as defined in ISO 13666:2019(E), section 3.7.1 (single-vision lens),
a position-specific single-vision spectacle lens as defined in ISO 13666:2019(E), section 3.7.2(position-specific single-vision lens),
a multifocal spectacle lens as defined in ISO 13666:2019(E), section 3.7.3 (multifocal lens),
a bifocal spectacle lens as defined in ISO 13666:2019(E), section 3.7.4 (bifocal lens),
a trifocal spectacle lens as defined in ISO 13666:2019(E), section 3.7.5 (trifocal lens),
a fused multifocal spectacle lens as defined in ISO 13666:2019(E), section 3.7.6 (fused multifocal lens),
a power-variation spectacle lens as defined in ISO 13666:2019(E), section 3.7.7 (power-variation lens),
a progressive-power spectacle lens as defined in ISO 13666:2019(E), section 3.7.8 (progressive-power lens).

Typically, the spectacle lens is the single-vision spectacle lens or the position-specific single-vision spectacle lens.

The spectacle lens may be a blank as defined in ISO 13666:2019(E), section 3.8.1. One surface layer or more surface layers forming or causing (i) one structure or (ii) a plurality of structures may be on an optically finished surface the blank. The other surface of the blank may be transferred to an optically finished surface afterwards.

The spectacle lens comprises or is based on an optical material. The optical material is as defined in ISO 13666:2019(E), section 3.3.1, a transparent material capable of being manufactured into optical components. The optical material typically comprises a thermosetting hard resin as defined in ISO 13666:2019(E), section 3.3.3, or a thermoplastic hard resin as defined in ISO 13666:2019(E), section 3.3.4. The optical material typically is having a uniform refractive index.

A “structure of a digital twin of a coated spectacle lens” is a mathematical description of a surface of the structure, the mathematical description not considering a mathematical description of a lens surface of the digital twin of the coated spectacle lens comprising the structure, for example not considering a mathematical description of a front surface comprising the structure. The structure of the digital twin of the coated spectacle lens is a single structure of the digital twin.

For characterizing the structure and not the lens surface of the digital twin of the coated spectacle lens comprising the structure, the mathematical description of the lens surface comprising the structure is a separate mathematical description from the mathematical description of the surface of the structure itself. The surface of the structure and the lens surface of the digital twin of the coated spectacle lens comprising the structure are mathematically described piecewise.

The surface of the structure of the digital twin of the coated spectacle lens may be selected from at least one of the following surfaces or may be pieced together from parts selected from at least one of the following surfaces:
a spherical surface as defined in ISO 13666:2019(E), section 3.4.1;
a part of a spherical surface;
a cylindrical surface as defined in ISO 13666:2019(E), section 3.4.2;
a part of a cylindrical surface;
an aspherical surface as defined in ISO 13666:2019(E), section 3.4.3;
a part of an aspherical surface;
a toroidal surface as defined in ISO 13666:2019(E), section 3.4.6;
a part of a toroidal surface;
an atoroidal surface as defined in ISO 13666:2019(E), section 3.4.7;
a part of an atoroidal surface;
a power-variation surface defined analogously as in ISO 13666:2019(E), section 3.4.10;
a part of a power-variation surface.

The structure of the digital twin of the coated spectacle lens typically is
a domain on a lens surface of the digital twin, the domain being part of one surface layer or more surface layers digitally added to a front surface and/or a back surface of a digital twin of a spectacle lens, typically the one or more surface layer(s) digitally added to the front surface of the digital twin of the spectacle lens, or
a domain of a lens surface of the digital twin, the domain being caused by one surface layer or more surface layers digitally added to a front surface and/or a back surface of a digital twin of a spectacle lens, typically the one or more surface layer(s) digitally added to the front surface of the digital twin of the spectacle lens.

The structure of the digital twin of the coated spectacle lens being the domain on the lens surface typically is an elevation, typically single elevation, which is part of one surface layer or more surface layers digitally added to the front surface and/or the back surface of the digital twin of the spectacle lens, typically the one or more surface layer(s) digitally added to the front surface of the digital twin of the spectacle lens. The structure of the digital twin of the coated spectacle lens typically is part of the one or more surface layer(s) digitally added to the front surface and/or the back surface of the digital twin of the spectacle lens when the structure is elevated with respect to the one or more surface layer(s).

The structure of the digital twin of the coated spectacle lens being the domain of the lens surface typically is a depression, typically single depression, which is caused by one surface layer or more surface layers digitally added to the front surface and/or the back surface of the digital twin of the spectacle lens, typically the one or more surface layer(s) digitally added to the front surface of the digital twin of the spectacle lens. The structure of the digital twin of the coated spectacle lens typically is caused by the one or more surface layer(s) digitally added to the front surface and/or the back surface of the digital twin of the spectacle lens when the one or more surface layer(s) is/are elevated with respect to the structure.

The surface of the domain, irrespective of whether being the elevation or the depression, is a piecewise mathematical description of the digital twin of the coated spectacle lens.

The domain of the structure on or of a lens surface is smaller than the lens surface of the digital twin of the coated spectacle lens comprising the structure.

The structure of the digital twin of the coated spectacle lens has a surface power which is different to a surface power of the lens surface of the digital twin of the coated spectacle lens comprising the structure outside a domain occupied by the structure. The surface power of the structure shall be defined analogously as in ISO 13666:2019(E), section 3.10.4 (surface power), as a local ability of the surface of the structure to change the calculated vergence of a digitally represented bundle of rays incident at the surface of the structure. The surface power of the structure typically is analogously as in note 1 to the entry in ISO 13666:2019(E), section 3.10.4, determined from a radius or radii of the surface of the structure and a refractive index of a material of the structure, and is calculated for digitally represented light incident or emergent in air. The refractive index may be an actual refractive index of a material of the structure or a nominal value. The refractive index of the material of the structure typically is assumed to be a same as a refractive index of an optical material of a digital twin of a spectacle lens. Typically, the refractive index of the material of the structure is assumed to be the same as the refractive index of the optical material of the digital twin of the spectacle lens, irrespective of whether the structure a) is part of one or more surface layer(s) digitally added to a lens surface of the digital twin of the spectacle lens or b) is caused by the one or more surface layer(s).

The surface power of a lens surface of the digital twin of the coated spectacle lens shall be defined analogously as in ISO 13666:2019(E), section 3.10.4 (surface power), as a local ability of the lens surface of a digital twin of a spectacle lens to change the calculated vergence of a digitally represented bundle of rays incident at the lens surface. The surface power of the lens surface is analogously as in note 1 to the entry in ISO 13666:2019(E), section 3.10.4, determined from a radius or radii of the lens surface of the digital twin of the spectacle lens and a refractive index of an optical material of the digital twin of the spectacle lens, and is calculated for digitally represented light incident or emergent in air. The refractive index may be an actual refractive index of the optical material of the digital twin of the spectacle lens or a nominal value. The surface power of the lens surface of the digital twin of the spectacle lens is assumed to be a same as the surface power of the lens surface of the digital twin of the coated spectacle lens not considering the structure and not considering one or more surface layer(s) digitally added to the lens surface of the digital twin of the spectacle lens.

A “predefined” structure of a digital twin of a coated spectacle lens is a structure of the digital twin as defined before, for which, with respect to a lens surface of the digital twin comprising the structure, at least one of the group consisting of
a surface of the structure, typically in the sense of surface shape, form or topography, typically selected or pieced together from the above exemplarily mentioned ones,
a surface power of the structure, defined analogously as in ISO 13666:2019(E), section 3.10.4 (surface power),
a domain of the structure, typically a domain on a lens surface occupied by the structure, and
a position of the structure on the lens surface, typically a discrete x,y,z position of the structure on the lens surface,
   is/are preset. Typically, the surface of the structure, the domain of the structure and the position of the structure with respect to the lens surface comprising the structure are preset.

A “structure of a coated spectacle lens” results from a transfer of the structure of the digital twin of the coated spectacle lens to physical reality, by manufacturing the coated spectacle lens. A “predefined” structure of the coated spectacle lens results from a transfer of the predefined structure of the digital twin of the coated spectacle lens to physical reality, by manufacturing the coated spectacle lens. The surface of the structure of the coated spectacle lens may be selected from at least one of the following surfaces or may be pieced together from parts selected from at least one of the following surfaces:
a spherical surface as defined in ISO 13666:2019(E), section 3.4.1;
a part of a spherical surface;
a cylindrical surface as defined in ISO 13666:2019(E), section 3.4.2;
a part of a cylindrical surface;
an aspherical surface as defined in ISO 13666:2019(E), section 3.4.3;
a part of an aspherical surface;
a toroidal surface as defined in ISO 13666:2019(E), section 3.4.6;
a part of a toroidal surface;
an atoroidal surface as defined in ISO 13666:2019(E), section 3.4.7;
a part of an atoroidal surface;
a power-variation surface as defined in ISO 13666:2019(E), section 3.4.10;
a part of a power-variation surface.

The structure of the coated spectacle lens typically is
a domain on a lens surface of the coated spectacle lens, the domain being part of one surface layer or more surface layers added to a front surface and/or a back surface of a spectacle lens, typically the one or more surface layer(s) added to the front surface of the spectacle lens, or
a domain on a lens surface of the coated spectacle lens, the domain being part of one surface layer or more surface layers added to a front surface and/or a back surface of a spectacle lens, typically the one or more surface layer(s) added to the front surface of the spectacle lens.

The structure of the coated spectacle lens being the domain on the lens surface typically is an elevation, typically a single elevation, which is part of one surface layer or more surface layers added to the front surface and/or the back surface of the spectacle lens, typically the one or more surface layer(s) added to the front surface of the spectacle lens. The structure of the coated spectacle lens typically is part of the one or more surface layer(s) added to the front surface and/or the back surface of the spectacle lens when the structure is elevated with respect to the one or more surface layer(s).

The structure of the coated spectacle lens being the domain of the lens surface typically is a depression, typically single depression, which is caused by one surface layer or more surface layers added to the front surface and/or the back surface of the spectacle lens, typically the one or more surface layer(s) added to the front surface of the spectacle lens. The structure of the coated spectacle lens typically is caused by the one or more surface layer(s) added to the front surface and/or the back surface of the spectacle lens when the one or more surface layer(s) is/are elevated with respect to the structure.

The domain of the structure on or of a lens surface is smaller than the lens surface of the coated spectacle lens comprising the structure. Typically, a smallest lateral expansion of the domain of the structure on or of the lens surface corresponds to a beam diameter as defined in ISO 11145:2018(E), section 3.3, in particular a beam diameter dᵤ(z) as defined in ISO 11145:2018(E), section 3.3.1, of a laser. For example, a domain on or of the lens surface having a diameter of 70 mm obtainable by a laser having a beam diameter dᵤ(z) of 25 μm accounts for 0.035% of the diameter.

The structure of the coated spectacle lens has a surface power which is different to a surface power of the lens surface of the coated spectacle lens comprising the structure outside a domain occupied by the structure. The surface power of the structure is defined as in ISO 13666:2019(E), section 3.10.4 (surface power), as a local ability of a surface of the structure to change the vergence of a bundle of rays incident at the surface. The surface power of the structure typically is as in note 1 to the entry in ISO 13666:2019(E), section 3.10.4, determined from a radius or radii of the surface of the structure and a refractive index (3.1.5) of a material of the structure, and is calculated for light (3.1.2) incident or emergent in air. The refractive index may be an actual refractive index of the material of the structure or a nominal value. The refractive index of the material of the structure typically is assumed to be a same as a refractive index of an optical material of a spectacle lens. Typically, the refractive index of the material of the structure is assumed to be the same as the refractive index of the optical material of the spectacle lens, irrespective of whether the structure a) is part of one or more surface layer(s) added to a lens surface of the spectacle lens or b) is caused by the one or more surface layer(s).

The surface power of a lens surface of the coated spectacle lens is defined as in ISO 13666:2019(E), section 3.10.4, as a local ability of a finished surface of a spectacle lens to change the vergence of a bundle of rays incident at the finished surface. The surface power of the lens surface is as in note 1 to the entry in ISO 13666:2019(E), section 3.10.4, determined from a radius or radii of the finished surface of the spectacle lens and a refractive index (3.1.5) of an optical material (3.3.1) of the spectacle lens, and is calculated for light (3.1.2) incident or emergent in air. The refractive index may be an actual refractive index of the optical material or a nominal value. The surface power of the finished surface of the spectacle lens is assumed to be a same as the surface power of the lens surface of the coated spectacle lens not considering the structure and not considering one or more surface layer(s) added to the finished surface of the spectacle lens.

Examples for a structure of a coated spectacle lens are:
a lenslet as disclosed in WO 2020/180817 A1 having a diameter of 0.5 mm or more up to 5 mm, or a lenslet having an add power of +0.25 D or more up to 5.0 D or an add power of −0.25 D or less, each compared to the base optical power of the lens;
an optical element as disclosed in WO 2022/251713 A1 having a desired shape and size;
a lenslet as disclosed in WO 2021/236687 A1 having an add power of +0.25 D or more up to +5.0 D or an add power of −0,25 D or less, each compared to the base optical power of the lens, or a lenslet having a diameter of 0.5 mm or more up to 5 mm;
a light modulating cell as disclosed in WO 2020/261213 A1 having a dimension and power as disclosed therein, for example in [00108], [00118], [00121], or [00122];
a single island-shaped area as disclosed in US 2017/0131567 A1 having an area of about 0.50 to 3.14 mm² and a circular shape of a diameter of about 0.8 to 2.0 mm;
a single optical element as disclosed in WO 2019/166659 A1 having a contour shape that is inscribable in a circle having a diameter greater than or equal to 0.8 mm and smaller than or equal to 3.0 mm;
a single one of the concentric rings as disclosed in WO 2019/166659 A1, FIG. 11b;
a single cylindrical microstructure as disclosed in CN 111103701 A having a radial width of 0.5 mm to 2 mm;
a single ring-shaped focusing structure as disclosed in PCT/EP2022/053854 having a width of equal or lower than 0.7 mm,
   a respective structure being a single elevation, which is part of one surface layer or more surface layers added to the front surface and/or the back surface of the spectacle lens, or a respective structure being a single depression, which is caused by one surface layer or more surface layers added to the front surface and/or the back surface of the spectacle lens.

A “domain of one structure on a lens surface of a digital twin of a coated spectacle lens” or a “domain of one structure on a lens surface of a coated spectacle lens” each shall define that a domain of one structure shall be limited by an onset line. The onset line passes along each onset of the one structure. An onset of the one structure shall represent, typically along a circumference or along a perimeter of the one structure, a first position in which a surface, typically in the sense of surface shape, form, or topography, of the one structure deviates from a surface of a lens surface comprising the one structure. A domain of one structure typically is limited by one onset line only if within the domain a surface of the one structure deviates in each discrete x,y,z position from a surface of a lens surface comprising the one structure, typically outside the domain occupied by the one structure. Examples for one structure occupying a domain on a lens surface limited by one onset line only are a lenslet as described in WO 2020/180817 A1 or a single island-shaped area as described in US 2017/0131567 A1.

A domain of one structure may be limited by an outer onset line and an inner onset line. The outer onset line passes along each outer onset of the one structure. The inner onset line passes along each inner onset of a same one structure. An outer onset shall represent, typically along a circumference or along a perimeter of the one structure, a first outer position in which a surface, typically in the sense of surface shape, form, or topography, of the one structure deviates from a surface of a lens surface comprising the one structure. The inner onset shall represent, typically along a structure-free domain of a lens surface surrounded or encircled by the same one structure, a first inner position in which a surface, typically in the sense of surface shape, form, or topography, of the same one structure deviates from a lens surface comprising the same one structure. A domain of one structure typically is limited by an outer onset line and an inner onset line if within the domain a surface of the one structure is not deviating in each discrete x,y, z position from a surface of a lens surface comprising the structure, typically outside the domain occupied by the one structure. One exemplary structure occupying a domain on a lens surface limited by one outer onset line and only one inner onset line is a simple ring-shaped structure, the ring-shaped structure surrounding or encircling a structure-free domain of a lens surface and being surrounded or encircled by a structure-free domain of the lens surface. One structure shall be considered as “ring-shaped” if it surrounds at least one structure-free domain of a lens surface and there is at least one path within the one structure which runs from at least one starting point within the one structure around a structure-free domain of a lens surface and to the same at least one starting point again. Ring-shaped may comprise circular, elliptical or otherwise curved rings encircling a structure-free domain of a lens surface and being encircled by a structure-free domain of the lens surface. A structure-free domain of a ring-shaped structure is a domain of the spectacle lens or of the lens surface outside a respective domain occupied by the ring-shaped structure encircled or surrounded by the ring-shaped structure. A structure-free domain of the spectacle lens is a domain of the spectacle lens or of the lens surface outside a respective domain occupied by the ring-shaped structure. Examples for one structure occupying a domain on a lens surface limited by one outer onset line and one inner onset line are a single one of the concentric rings as described in WO 2019/166659 A1, FIG. 11b, a single cylindrical microstructure as disclosed in CN 111103701 A or a single ring-shaped focusing structure as disclosed in PCT/EP2022/053854.

A “domain of a plurality of structures on a lens surface of a digital twin of a coated spectacle lens” or a “domain of a plurality of structures on a lens surface of a coated spectacle lens” each shall define that each structure of the plurality of structures shall be limited by an onset line. The onset line passes along each onset of each structure of the plurality of structures. An onset of each structure of the plurality of structures shall represent, typically along a circumference or along a perimeter of each structure, a first position in which a surface, typically in the sense of surface shape, form, or topography, of each structure deviates from a surface of a lens surface comprising the structure of the plurality of structures. A domain of each structure typically is limited by one onset line only if within the domain a surface of each structure deviates in each discrete x,y,z position from a surface of a lens surface comprising the structure of the plurality of structures, typically outside each domain occupied by each structure of the plurality of structures. Examples for a plurality of structures each occupying a domain on a lens surface each limited by one onset line only are lenslets as described in WO 2020/180817 A1 or single island-shaped areas as described in US 2017/0131567 A1.

A domain of each structure of a plurality of structures, i.e., each domain of a same structure of the plurality of structures, may be limited by an outer onset line and an inner onset line. The outer onset line passes along each outer onset of each structure of the plurality of structures. The inner onset line passes along each inner onset of a same structure of the plurality of structures. An outer onset shall represent, typically along a circumference or along a perimeter of each structure of the plurality of structures, a first outer position in which a surface, typically in the sense of surface shape, form, or topography, of each structure deviates from a surface of a lens surface comprising the structure of the plurality of structures. The inner onset shall represent, typically along a structure-free domain of a lens surface surrounded or encircled by a same structure of the plurality of structures, a first inner position in which a surface, typically in the sense of surface shape, form, or topography, of the same structure deviates from a lens surface comprising the same structure of the plurality of structures. A domain of each structure of the plurality of structures, i.e., each domain of the same structure of the plurality of structures, typically is limited by an outer onset line and an inner onset line if within the domain a surface of each structure, i.e., each same structure, is not deviating in each discrete x,y,z position from a surface of a lens surface comprising the structure of the plurality of structures, typically outside each domain occupied by each structure of the plurality of structures. Exemplary structures occupying a domain on a lens surface limited by one outer onset line and only one inner onset line are a plurality of simple ring-shaped structures, each ring-shaped structure surrounding or encircling one structure-free domain of a lens surface and being surrounded or encircled by a structure-free domain of the lens surface. Each structure of the plurality of structures shall be considered as “ring-shaped” if it surrounds at least one structure-free domain of a lens surface and there is at least one path within each structure which runs from at least one starting point within each structure around the at least one structure-free domain of the lens surface and to the same at least one starting point again. Ring-shaped may comprise circular, elliptical or otherwise curved rings encircling a structure-free domain of a lens surface and being encircled by a structure-free domain of the lens surface. Examples for a plurality of structures each occupying a domain on a lens surface limited by an outer onset line and one inner onset line are concentric rings as described in WO 2019/166659 A1, FIG. 11b, cylindrical microstructures as disclosed in CN 111103701 A or ring-shaped focusing structures as disclosed in PCT/EP2022/053854.

A “plurality of structures of a digital twin of a coated spectacle lens” is a mathematical description of a surface of each structure, each mathematical description not considering a mathematical description of a lens surface of the digital twin of the coated spectacle lens comprising the plurality of structures. The plurality of structures of the digital twin of the coated spectacle lens is more than one structure, the structure of the digital twin of the coated spectacle lens as defined before. In case the digital twin of the coated spectacle lens comprises for example two structures, one structure may be formed as elevation on one lens surface of the digital twin, e.g., the front surface, and one structure may be formed as a) elevation on the other lens surface of the digital twin, e.g., the back surface, as b) elevation on the same lens surface of the digital twin, i.e., the front surface, as c) depression on the other lens surface of the digital twin, or as d) depression on the same lens surface of the digital twin. In the plurality of structures each structure may be an identical type of structure, e.g., a plurality of only one structure of the exemplarily mentioned before. An identical type of structure may comprise an identical surface and is either of an identical dimension or of a different dimension. Alternatively, the plurality of structures may comprise different types of structures, selected for example from any one of the exemplarily mentioned before. In the plurality of structures, the structures may adjoin each other or may be distanced from each other. Alternatively, a first part of the plurality of structures may adjoin each other and a second part of the plurality of structures may be distanced from each other.

In the plurality of structures, a surface power of each structure is different to a surface power of a lens surface comprising the plurality of structures outside each domain occupied by each structure of the plurality of structures. In the plurality of structures each structure of the plurality of structures may be responsible for a same value in surface power difference. In the plurality of structures, at least one structure of the plurality of structures may be responsible for a value in surface power difference which is different to other values in surface power difference caused by other structures of the plurality of structures.

A “predefined” plurality of structures of a digital twin of a coated spectacle lens is more than one structure of the digital twin, the structure as defined before, for which, with respect to a lens surface of the digital twin comprising the plurality of structures, at least one of the group consisting of
a surface of each structure, surface typically in the sense of surface shape, form, or topography, typically selected or pieced together from the above exemplarily mentioned ones,
a surface power of each structure, defined analogously as in ISO 13666:2019(E), section 3.10.4 (surface power),
a domain of each structure, typically a domain on a lens surface occupied by each structure,
a position of each structure on the lens surface, typically each discrete x,y,z position of each structure on the lens surface,
   is/are preset. Typically, the surface of each structure, the domain of each structure and the position of each structure with respect to the lens surface comprising the respective structure are preset.

A “plurality of structures of a coated spectacle lens” results from a transfer of the structures of a digital twin of a coated spectacle lens to physical reality, by manufacturing the coated spectacle lens. A “predefined” plurality of structures of the coated spectacle lens results from a transfer of the predefined structures of a digital twin of the coated spectacle lens to physical reality, by manufacturing the coated spectacle lens. The plurality of structures of the coated spectacle lens is more than one structure, the structure of the coated spectacle lens as defined before. In case the coated spectacle lens comprises for example two structures, one structure may be formed as elevation on one lens surface of the coated spectacle lens, e.g., the front surface, and one structure may be formed as a) elevation on the other lens surface of the coated spectacle lens, e.g., the back surface, as b) elevation on the same lens surface, i.e., the front surface, as c) depression on the other lens surface of the coated spectacle lens, or as d) depression on the same lens surface of the coated spectacle lens. In the plurality of structures each structure may be an identical type of structure, e.g., a plurality of only one type of structure of the exemplarily mentioned before. An identical type of structure may comprise an identical surface and is either of an identical dimension or of a different dimension. Alternatively, the plurality of structures may comprise different types of structures, selected for example from any one of the exemplarily mentioned before. In the plurality of structures, the structures may adjoin each other or may be distanced from each other. Alternatively, a first part of the plurality of structures may adjoin each other and a second part of the plurality of structures may be distanced from each other.

In the plurality of structures, a surface power of each structure is different to a surface power of a lens surface comprising the plurality of structures outside each domain occupied by each structure of the plurality of structures. In the plurality of structures each structure of the plurality of structures may be responsible for a same value in surface power difference. In the plurality of structures, at least one structure of the plurality of structures may be responsible for a value in surface power difference which is different to other values in surface power difference caused by other structures of the plurality of structures.

Examples for the plurality of structures of the coated spectacle lens are:
a plurality of the lenslets disclosed in WO 2020/180817 A1, each having a diameter of 0.5 mm or more up to 5 mm, or a lenslet having an add power of +0.25 D or more up to 5.0 D or an add power of −0.25 D or less, each compared to the based optical power of the lens;
a plurality of optical elements as disclosed in WO 2022/251713 A1, each having a desired shape and size;
a plurality of the lenslets disclosed in in WO 2021/236687 A1, each having an add power of +0.25 D or more up to +5.0 D or an add power of −0,25 D or less, each compared to the base optical power of the lens, or each having a diameter of 0.5 mm or more up to 5 mm;
a plurality of the light modulating cells disclosed in WO 2020/261213 A1, each having a dimension and power as disclosed therein, for example in [00108], [00118], [00121], or [00122];
a plurality of the island-shaped areas disclosed in US 2017/0131567 A1, each having an area of about 0.50 to 3.14 mm², a circular shape of a diameter of about 0.8 to 2.0 mm and a distance between the island-shaped areas of equal to a value of a radius of diameter/2;
a plurality of the optical elements disclosed in WO 2019/166659 A1, each having a contour shape that is inscribable in a circle having a diameter greater than or equal to 0.8 mm and smaller than or equal to 3.0 mm, the more than one optical elements may be arranged contiguously as defined on page 15, line 27 to page 16, line 8 of WO 2019/166659 A1 or non-contiguously;
a plurality of the concentric rings disclosed in WO 2019/166659 A1, FIG. 11b, the concentric rings arranged spaced apart from each other;
a plurality of the cylindrical microstructures disclosed in CN 111103701 A, each having a radial width of 0.5 mm to 2 mm, a distance between the different cylindrical microstructures is 0.5 mm to 3 mm;
a plurality of the ring-shaped focusing structures disclosed in PCT/EP2022/053854, each having a width of equal or lower than 0.7 mm and a spectacle lens comprising the more than one ring-shaped focusing structure is characterized by a surface-based fill factor defined as a surface area ratio of the surface area of an innermost of the ring-shaped focusing structures and a sum of the surface area of the innermost ring-shaped focusing structures and an area of a peripheral clear zone being larger than 17% and equal or lower than 70% for the width in a range of 0.6 mm to 0.7 mm,
   a structure of the plurality of structures being an elevation, which is part of one surface layer or more surface layers added to the front surface and/or the back surface of the spectacle lens, or a structure of the plurality of structures being a depression, which is caused by one surface layer or more surface layers added to the front surface and/or the back surface of the spectacle lens.

The before mentioned examples for the plurality of structures of the coated spectacle lens may be positioned with respect to a lens surface comprising the plurality of structures as described in the respective before mentioned citation.

A “lens surface of a digital twin of a coated spectacle lens” is a mathematical description of a front surface of the digital twin of the coated spectacle lens or a mathematical description of a back surface of the digital twin of the coated spectacle lens. The mathematical description of the front surface and the mathematical description of the back surface are piecewise mathematical descriptions, not considering a piecewise mathematical description of a structure or of each structure of a plurality of structures. The lens surface of the front surface and/or the lens surface of the back surface of the digital twin of the coated spectacle lens each is as defined in ISO 13666:2019(E), section 3.4 or is defined analogously as in ISO 13666:2019(E), section 3.4. The lens surface may be formed as one of the following:
as a spherical surface as defined in ISO 13666:2019(E), section 3.4.1,
as a cylindrical surface as defined in ISO 13666:2019(E), section 3.4.2,
as an aspherical surface as defined in ISO 13666:2019(E), section 3.4.3,
as a toroidal surface as defined in ISO 13666:2019(E), section 3.4.6,
as an atoroidal surface as defined in ISO 13666:2019(E), section 3.4.7,
as a power-variation surface defined analogously as in ISO 13666:2019(E), section 3.4.10.
   The lens surface of the front surface and the lens surface of the back surface of the digital twin of the coated spectacle lens may be formed of a same lens surface or of a different lens surface.

A “lens surface of a coated spectacle lens” results from a transfer of a lens surface of a digital twin of the coated spectacle lens to physical reality, by manufacturing the coated spectacle lens. The lens surface of the front surface and/or the lens surface of the back surface of the coated spectacle lens each is as defined in ISO 13666:2019(E), section 3.4 and may be formed as one of the following:
as a spherical surface as defined in ISO 13666:2019(E), section 3.4.1,
as a cylindrical surface as defined in ISO 13666:2019(E), section 3.4.2,
as an aspherical surface as defined in ISO 13666:2019(E), section 3.4.3,
as a toroidal surface as defined in ISO 13666:2019(E), section 3.4.6,
as an atoroidal surface as defined in ISO 13666:2019(E), section 3.4.7,
as a power-variation surface as defined in ISO 13666:2019(E), section 3.4.10.

A “lens surface of a digital twin of a spectacle lens” is a mathematical description of a front surface of the digital twin of the spectacle lens or a mathematical description of a back surface of the digital twin of the spectacle lens. The lens surface of the front surface and the lens surface of the back surface may be formed of a same lens surface or of a different lens surface. The lens surface of the front surface and the lens surface of the back surface of the digital twin of the spectacle lens typically is of a same lens surface as a respective lens surface of a digital twin of a coated spectacle lens. The lens surface of the digital twin of the coated spectacle lens has been described before. Any differences in the lens surfaces of the digital twin of the spectacle lens and the respective lens surface of a digital twin of the coated spectacle lens typically shall be neglected.

A “lens surface of a spectacle lens” results from a transfer of a lens surface of a digital twin of the spectacle lens in physical reality, by manufacturing the spectacle lens. The lens surface of the spectacle lens is assumed to be a same as the respective lens surface of a coated spectacle lens. One or more surface layers added to a lens surface of the spectacle lens shall be neglected.

“Determining” laser process parameters means to preset or predefine the laser process parameters to transfer (i) one predefined structure or (ii) a plurality of predefined structures of a digital twin of a coated spectacle lens in physical reality. The (i) one predefined structure or (ii) the plurality of predefined structures of the digital twin of the coated spectacle lens is/are transferred to physical reality by manufacturing the coated spectacle lens. The laser process parameters are preset or predefined to achieve the coated spectacle lens comprising (i) one structure or (ii) a plurality of structures corresponding to the (i) one predefined structure or the (ii) plurality of predefined structures of the digital twin of the coated spectacle lens. Typically, the laser process parameters are preset or predefined to achieve a coated spectacle lens comprising on a front surface and/or on a back surface, typically on the front surface, one or more surface layer(s) comprising, typically the one or more surface layer(s) forming or causing, (i) one structure or (ii) a plurality of structures corresponding to the (i) one predefined structure or the (ii) plurality of structures of the digital twin of the coated spectacle lens.

Determining laser process parameter typically means to preset or predefine the laser process parameters and their respective settings to transfer (i) one predefined structure or (ii) a plurality of predefined structures of a digital twin of a coated spectacle lens to physical reality, as described before. The laser process parameters and their respective settings are preset or predefined to achieve the coated spectacle lens comprising (i) one structure or (ii) a plurality of structures corresponding to the (i) one predefined structure or the (ii) plurality of predefined structures of the digital twin of the coated spectacle lens.

The preset or predefined laser process parameters may comprise a predetermined set of laser process parameters whose types of laser process parameters may be varied to achieve a coated spectacle lens comprising (i) one structure or (ii) a plurality of structures corresponding to (i) one predefined structure or (ii) a plurality of predefined structures of a respective digital twin of the coated spectacle lens. The preset or predefined laser process parameters may comprise a predetermined set of laser process parameters whose respective settings may be varied to achieve a coated spectacle lens comprising (i) one structure or (ii) a plurality of structures corresponding to (i) one predefined structure or (ii) a plurality of predefined structures of a respective digital twin of the coated spectacle lens.

The preset or predefined laser process parameters may comprise one predetermined set of laser process parameters whose types of laser process parameters and their respective settings are preset to achieve a coated spectacle lens comprising (i) one structure or each of (ii) a plurality of structures corresponding to (i) one predefined structure or to each of (ii) a plurality of predefined structures of a respective digital twin of the coated spectacle lens.

The preset or predefined laser process parameters may comprise more, typically at least two, predetermined sets of laser process parameters whose types of laser process parameters and their respective settings are preset to achieve a coated spectacle lens comprising a same (i) one structure or a same structure out of a (ii) plurality of structures corresponding to a same (i) one predefined structure or a same predefined structure out of a (ii) plurality of predefined structures of a respective digital twin of the coated spectacle lens.

To achieve a “same” structure, irrespective of regarding one single structure or one structure out of a plurality of structures, means that one predetermined set or more predetermined sets of laser process parameters has/have to be determined to achieve a coated spectacle lens comprising the (i) one structure or the (ii) one structure out of a plurality of structures corresponding to (i) one predefined structure or one predefined structure out of (ii) a plurality of predefined structures of a respective digital twin of the coated spectacle lens.

Typically, the (i) one predefined structure or the (ii) plurality of predefined structures is/are transferred to physical reality by at least the following manufacturing step:
selectively curing a coating composition using laser radiation, the laser radiation as defined in ISO 11145:2018(E), section 3.19.4, or a laser beam, the laser beam as defined in ISO 11145:2018(E), section 3.19.5, by applying the determined laser process parameters, typically selectively curing a coating composition on a front surface and/or on a back surface of a spectacle lens using laser radiation or a laser beam by applying the determined laser process parameters.

“Selectively curing” a coating composition means that the coating composition applied to a front surface and/or a back surface of a spectacle lens, typically applied to fully cover the front surface and/or the back surface, is cured or precured in at least one of
a preset position of the front surface,
a preset position of the back surface,
within a preset domain of the front surface,
within a preset domain of the back surface.

The coating composition is applied to “fully cover” the front surface and/or to “fully cover” the back surface of the spectacle lens when the coating composition completely covers the front surface and/or the back surface. Alternatively, applied to fully cover may comprise that the coating composition is applied to fully cover one domain or more domains of the front surface and/or the back surface, the domain(s) being selected to comprise (i) one structure or (ii) a plurality of structures of a resulting coated spectacle lens.

One predefined structure of a digital twin of a coated spectacle lens is “corresponding” to one structure of a coated spectacle lens when after transferring the digital twin to physical reality, i.e., when after manufacturing the coated spectacle lens at least one of a surface, a position, and a domain each of the one structure correspond to the one predefined structure. The one structure of the coated spectacle lens is corresponding to the one structure of the digital twin of the coated spectacle lens when
one surface layer of the coated spectacle lens is forming or causing the one structure, or
more surface layers of the coated spectacle lens are forming or causing the one structure.

A plurality of predefined structures of a digital twin of a coated spectacle lens are “corresponding” to a plurality of structures of a coated spectacle lens when after transferring the digital twin to physical reality, i.e., when after manufacturing the coated spectacle lens at least one of each surface, each position, and each domain of each structure of the plurality of structures correspond to a respective predefined structure of the plurality of predefined structures. The plurality of structures of the coated spectacle lens is corresponding to the plurality of predefined structures of the digital twin of the coated spectacle lens when
one surface layer of the coated spectacle lens is forming or causing the plurality of structures, or
more surface layers of the coated spectacle lens are forming or causing the plurality of structures.

“Laser process parameters” are parameters which are to be determined for at least one of the group consisting of:
a laser, the laser as defined in ISO 11145:2018(E), section 3.19.1, the laser being either a continuous wave laser as defined in ISO 11145:2018(E), section 3.19.2, or a pulsed laser as defined in ISO 11145:2018(E), section 3.19.3;
a laser device, the laser device as defined in ISO 11145:2018(E), section 3.19.6;
a laser assembly, the laser assembly as defined in ISO 11145:2018(E), section 3.19.7; or
a laser unit, the laser unit as defined in ISO 11145:2018(E), section 3.19.8.

With the choice of a type of the laser, the laser device, the laser assembly, or the laser unit, laser parameters and typically each of their respective settings inherent to the respective type are preset. Laser parameters and their respective settings being inherent to the type of the laser, the laser device, the laser assembly, or the laser unit are for example selected from at least one of the group consisting of:
a beam diameter as defined in ISO 11145:2018(E), section 3.3, in particular a beam diameter dᵤ(z) as defined in ISO 11145:2018(E), section 3.3.1, or a beam diameter d_{σ}(z) as defined in ISO 11145:2018(E), section 3.3.2;
a beam radius as defined in ISO 11145:2018(E), section 3.4, in particular a beam radius wᵤ(z) as defined in ISO 11145:2018(E), section 3.4.1, or a beam radius w_{σ}(z) as defined in ISO 11145:2018(E), section 3.4.2;
a beam width as defined in ISO 11145:2018(E), section 3.5, in particular a beam width d_{x,u}(z), d_{y,u}(z) as defined in ISO 11145:2018(E), section 3.5.1, or a beam width d_{σx}(z), d_{σy}(z) as defined in ISO 11145, section 3.5.2;
a beam cross-sectional area as defined in ISO 11145:2018(E), section 3.6, in particular a beam cross-sectional area Aᵤ(z) as defined in ISO 11145:2018(E), section 3.6.1, or a beam cross-sectional area A_{σ}(z) as defined in ISO 11145:2018(E), section 3.6.2;
a wavelength of laser radiation or of a laser beam.

Therefore, the method for designing a digital twin of a coated spectacle lens for the purpose of a use of the digital twin for manufacturing a coated spectacle lens typically comprises the step of
selecting laser parameters inherent to a type of at least one of the group selected from a laser, a laser device, a laser assembly, and a laser unit.

Typically, selecting laser parameters inherent to the type of the laser, the laser device, the laser assembly, or the laser unit and typically each of their respective settings considers at least one of the following:
a domain of a structure to be achieved, in particular a smallest lateral expansion of the domain of the structure on or of a lens surface. Typically the smallest lateral expansion corresponds to a beam diameter as defined in ISO 11145:2018(E), section 3.3, in particular a beam diameter dᵤ(z) as defined in ISO 11145:2018(E), section 3.3.1;
an ability of a laser radiation to cure or precure a coating composition.

With the choice of the type of the laser, the laser device, the laser assembly, or the laser unit, laser process parameters not being inherent to the respective type are to be determined. Typically, with the choice of the type of the laser, the laser device, the laser assembly, or the laser unit, typically laser process parameters and their settings not being inherent to the respective type are to be determined. Laser process parameters not being inherent to the type of the laser, the laser device, the laser assembly, or the laser unit are for example selected from at least one of the group consisting of:
a power and energy as defined in ISO 11145:2018(E), section 3.13, in particular at least one of an average energy density as defined in ISO 11145:2018(E), section 3.13.1, an average power density as defined in ISO 11145:2018(E), section 3.13.2, a pulse energy as defined in ISO 11145:2018(E), section 3.13.3, an energy density as defined in ISO 11145:2018(E), section 3.13.4, a continuous wave power as defined in ISO 11145:2018(E), section 3.13.5, a power density as defined in ISO 11145:2018(E), section 3.13.6, a pulse power as defined in 3.13.7, an average power as defined in ISO 11145:2018(E), section 3.13.8, and a peak power as defined in ISO 11145:2018(E), section 3.13.9;
an efficiency as defined in ISO 11145:2018(E), section 3.20, in particular a laser efficiency as defined in ISO 11145:2018(E), section 3.20.1;
a pulse duration as defined in ISO 11145:2018(E), section 3.14, in particular at least one of a pulse duration as defined in ISO 11145:2018(E), section 3.14.1; a full width half maximum (FWHM) pulse duration as defined in ISO 11145:2018(E), section 3.14.2, a pulse repetition rate as defined in ISO11145:2018(E), section 3.14.3;
a scan speed which shall be defined as moving speed of a laser beam on a coated lens surface; the higher the scan speed, the less time the laser beam resides in a discrete x,y position of the coated lens surface, thus less power and energy is applied to the position;
a repetition time which shall be defined as repeated times a laser beam comes across a discrete x,y position of a coated spectacle lens.

For determining the laser process parameters to achieve a coated spectacle lens comprising (i) one structure or (ii) a plurality of structures corresponding to (i) one predefined structure or (ii) a plurality of predefined structures of a respective digital twin of the coated spectacle lens, typically numerical data comprising
discrete x,y,z positions of or on a front surface of a digital twin of a coated spectacle lens, i.e., a discretization of the front surface, or
discrete x,y,z positions of or on a back surface of a digital twin of a coated spectacle lens, i.e., a discretization of the back surface, or
discrete x,y,z positions of or on a front surface of a digital twin of a coated spectacle lens and discrete x,y,z of or on a back surface of the digital twin, i.e., a discretization of the front surface and a discretization of the back surface,
   is/are considered. Typically, the discretization is adapted or selected to consider a beam diameter as defined in ISO 11145:2018(E), in particular a beam diameter dᵤ(z) as defined in ISO 11145:2018(E), section 3.3.1, of a laser.

Typically, numerical data with respect to the front surface, with respect to the back surface or with respect to the front and back surface are considered, depending on the surface(s) of the digital twin of the coated spectacle lens to comprise (i) one predefined structure or (ii) a plurality of predefined structures.

Typically, the discretization of the front surface, the discretization of the back surface or the discretization of the front and back surface is done to allow a determination of laser process parameters considering a lens surface of the front surface, and/or a lens surface of the back surface of the digital twin of the coated spectacle lens.

Typically, the discretization of the front surface, the discretization of the back surface or the discretization of the front and back surface is done for a domain or in a domain of the respective surface. The discretization for a domain or in a domain means that not a complete lens surface of the front surface or a complete lens surface of the back surface is discretized but only the lens surface of or in the domain. A digital twin of a coated spectacle lens comprising one predefined structure comprises the one predefined structure in the domain. A digital twin of a coated spectacle lens comprising a plurality of predefined structures comprises a) a plurality of the domains, each comprising one predefined structure or b) one the domain comprising a plurality of structures. The discretization for a domain or in a domain allows a determination of laser process parameters considering a lens surface of or in the domain.

Determining laser process parameters “based on curing characteristics of a coating composition” means that the laser process parameters are determined such that one coating compositions is or more coating compositions are cured or precured by using laser radiation or a laser beam. Typically, determining laser process parameters based on curing characteristics of a coating composition means that the laser process parameters are determined such as to selectively cure one coating composition or more coating compositions by using laser radiation or a laser beam. Curing, precuring or selectively curing one coating composition or curing, precuring or selectively curing coating compositions result in one surface layer or more surface layers of a coated spectacle lens forming or causing (i) one structure or (ii) a plurality of structures corresponding to (i) one predefined structure or (ii) a plurality of predefined structures of a digital twin of the coated spectacle lens. The curing characteristics of the coating composition or the coating compositions are dependent from for example chemical components comprised in the coating composition or a layer thickness in which the coating composition is applied to a front surface and/or a back surface of a spectacle lens.

The coating composition or the coating compositions whose curing characteristics are considered when determining the laser process parameters typically are applied to a lens surface of a spectacle lens by spin coating or dip coating.

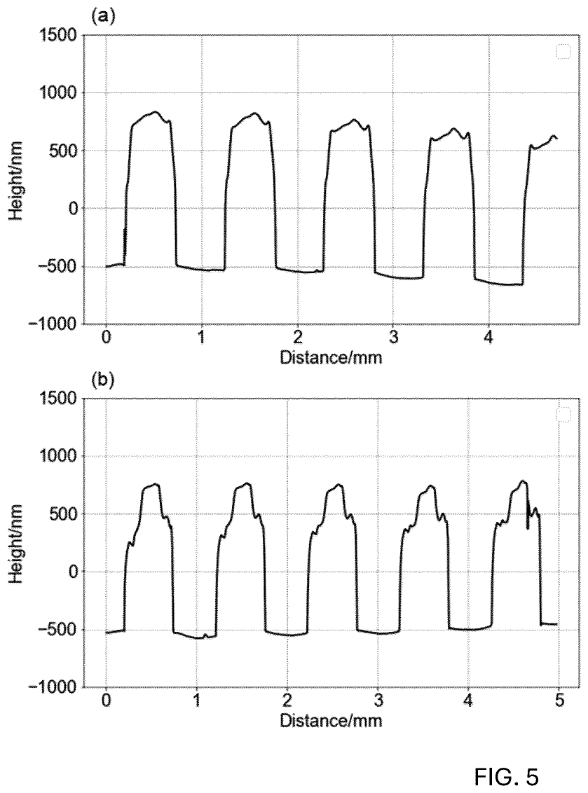

In contrast to WO 2020/180817 A1, in particular page 2, lines 10 to 12, describing an exposure of an ophthalmic lens at discrete locations to laser radiation to shape a material at the surface; or page 2, lines 18 to 24, describing an exposure to laser radiation to locally reshape the material; or page 3, lines 6 to 7, page 13, lines 18 to 25, and FIG. 5B, describing to locally melt the material; laser process parameters are determined considering curing characteristics of a coating composition, i.e., the laser process parameters are determined such that an uncured coating composition or uncured coating compositions is/are cured or precured when applying laser radiation or a laser beam with the determined laser process parameters to the uncured coating composition(s). The laser process parameters are not determined to shape or reshape by for example locally melting a cured coating composition, i.e., a surface layer, or a precured coating composition.

In contrast to WO 2022/251713 A1, in particular page 7, [0034], the laser process parameters are determined such as to cure or precure an uncured coating composition or uncured coating compositions and not to melt a laser interaction layer, to cause the laser interaction layer and/or the lens material to foam or cavitate, to result in a colour change or to be removed by ablation.

In contrast to WO 2020/261213 A1, in particular page 15/16, [00108], the laser process parameters are determined such as to cure or precure an uncured coating composition or uncured coating compositions and not to form a light modulating cell by a laser in a subtractive or localized lens material change process.

In contrast to WO 2021/236687 A2, in particular page 17, lines 9 to 15, describing the formation of recesses by ablating material from the lens surface using laser radiation, or the formation of small depressions, bubbles, or craters by interaction of lens material with focused laser radiation, the laser process parameters are such as to cure or precure an uncured coating composition or uncured coating compositions by the application of laser radiation. The laser process parameters are determined such that applied laser radiation does not interact with the lens surface of the spectacle lens and thus does not damage the lens surface of the spectacle lens. Only the one coating composition or the more coating compositions applied to a respective lens surface are cured or precured in (a) position(s) or in (a) domain(s) to result in one structure or in a plurality of structures. The structure(s) is/are formed of cured/precured coating composition(s), for example, when in case of a plurality of concentric ring-shaped structures the plurality of concentric ring-shaped structures consist of the cured/precured coating composition(s). The structure(s) is/are caused by cured/precured coating composition(s), for example, when in case of a plurality of concentric ring-shaped structure the structure-free zones consist of the cured/precured coating composition(s).

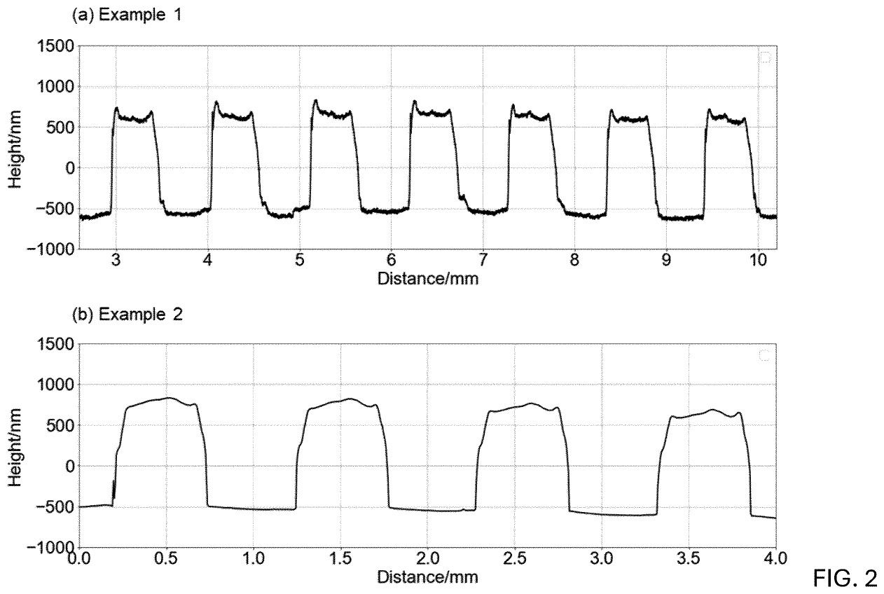

In contrast to WO 2021/236687 A2, in particular page 15, lines 28 to 30 in connection with FIG. 2 describing the formation of optical elements by inkjetting a curable material onto a surface of a lens ophthalmic blank and then curing the material to set the optical elements in the pattern, page 16, lines 13 to 16 suggests UV lamps or thermal curing, laser process parameters are determined to cure by the application of laser radiation the curable material only in a predefined position or domain.

The problem has been solved by the method of claim 1. With the before described method a digital twin of a coated spectacle lens comprising any one of the before mentioned structures as well as any arbitrarily selected structure is designed. As the before mentioned structures being proposed to be suitable to prevent or to control a progression of myopia or hyperopia the digital twin may be also designed in that any designed structure thereof may be used in prevention or control of myopia or hyperopia progression.

In an exemplary embodiment of the disclosure the method configured for designing a digital twin of a coated spectacle lens by means of a computer for the purpose of a use of the digital twin for manufacturing the coated spectacle lens is characterized in
determining laser process parameters such as to comprise at least one of
   a spatial variation in z direction of a setting of one laser process parameter or more laser process parameters,
   a spatial variation in x,y direction of a setting of one laser process parameter or more laser process parameters,
      each to achieve (i) one predefined structure or (ii) a plurality of predefined structures or (iii) a same predefined structure out of the plurality of predefined structures.

Typically, the method for configured for designing a digital twin of a coated spectacle lens by means of a computer for the purpose of a use of the digital twin for manufacturing the coated spectacle lens is characterized in
determining laser process parameters such as to comprise at least one of
   a spatial variation in z direction of a setting of one laser process parameter or more laser process parameters,
   a spatial variation in x,y direction of a setting of one laser process parameter or more laser process parameters,
      each to achieve the coated spectacle lens comprising (i) one structure corresponding to the one predefined structure or (ii) a plurality of structures corresponding to the plurality of predefined structures or (iii) a same structure out of a plurality of structures corresponding to the same predefined structure out of the plurality of predefined structures.

A surface normal at either an apex of a front surface of a digital twin of a spectacle lens or an apex of a back surface of a digital twin of a spectacle lens shall define an origin of an x,y,z coordinate system and a “z direction.”

An “x,y direction” shall be in a tangential plane to either the front surface at the apex or the back surface at the apex. An x direction and a y direction shall be perpendicular to each other in the tangential plane.

Instead of the surface normal at the apex of the front surface or instead of the surface normal at the apex of the back surface an optical center of the digital twin of the spectacle lens may define an origin of the x,y,z coordinate system and a surface normal at the optical center may define a z direction. The optical center of a digital twin of a spectacle lens is defined analogously as in ISO 13666:2019(E), section 3.2.15, as intersection of the optical axis with the front surface of the digital twin of the spectacle lens. The x,y direction then is in the tangential plane to the intersection with the front surface. In the tangential plane the x direction and the z direction are perpendicular to each other.

In case a front surface or a back surface of a digital twin of a spectacle lens is for example a power-variation surface or another surface without an unambiguously definably apex, typically a surface normal at a fitting point of the digital twin of the spectacle lens shall define the origin of the x,y,z coordinate system and a primary direction may define a z direction. The fitting point of a digital twin of a spectacle lens is defined analogously as in ISO 13666:2019(E), section 3.2.34, a point on the front surface of digital twin of a spectacle lens or a digital twin of a blank stipulated by the manufacturer for virtual positioning the respective digital twin in front of an eye. The primary direction of a digital twin of a spectacle lens is defined analogously as in ISO 13666:2019(E), section 3.2.25, as direction of a virtually represented line of sight, usually taken to be the horizontal, to an object at an infinite distance assumed with habitual head and body posture when assumed looking straight ahead in unaided vision. In that case, the x,y direction is in the plane perpendicular to the primary direction. In the plane perpendicular to the primary direction the x direction and the y direction are perpendicular to each other.

A “spatial variation” of laser process parameters shall mean that a setting of one laser process parameter or a setting of more laser process parameters is/are varied dependent on a discrete x,y,z position to achieve at least one of (i) one predefined structure, (ii) a plurality of predefined structures, (iii) a same predefined structure out of a plurality of predefined structures, each of a digital twin of a coated spectacle lens. “A discrete x,y,z position” typically comprises one discrete x,y,z position or more discrete x,y,z positions.

A “spatial variation in z direction” of laser process parameters shall mean that a setting of one laser process parameter or a setting of more laser process parameters is/are varied with respect to a discrete x,y position in z direction only to achieve (i) one predefined structure or a (ii) plurality of predefined structures or to achieve (iii) a same predefined structure out of a plurality of predefined structures each of a digital twin of a coated spectacle lens. “A discrete x,y position” typically comprises one discrete x,y position or more discrete x,y positions.

A “spatial variation in x,y direction” of laser process parameters shall mean that a setting of one laser process parameter or a setting of more laser process parameters is/are varied with respect to discrete z positions in x,y direction only to achieve (i) one predefined structure or a (ii) plurality of predefined structures or to achieve a (iii) same predefined structure out of a plurality of predefined structures each of a digital twin of a coated spectacle lens. “Discrete z positions” typically comprises one z position for one x,y position, different z positions for an identical x,y position or different z positions for different x,y positions.

A “spatial variation in x,y,z direction” of laser process parameters shall mean that a setting of one laser process parameter or a setting of more laser process parameters is/are varied with respect to discrete x,y,z positions in x,y direction and in z direction to achieve (i) one predefined structure or a (ii) plurality of predefined structures or (iii) a same predefined structure out of a plurality of predefined structures each of a digital twin of a coated spectacle lens. “Discrete x,y,z positions” typically comprises x,y,z positions which are different from each other.

The spatial variation of laser process parameters in at least one of a z direction, an x,y direction and an x,y,z direction set such as to achieve (i) one predefined structure of a digital twin of a coated spectacle lens shall mean that the respective spatial variation is set such as to achieve a same (i) one predefined structure of the digital twin.

The spatial variation of laser process parameters in at least one of a z direction, an x,y direction and an x,y,z direction set such as to achieve (ii) a plurality of predefined structures of a digital twin of a coated spectacle lens shall typically comprise that the respective spatial variation is set such as to achieve (ii) a plurality of same predefined structures of the digital twin. In the plurality of same predefined structures typically each predefined structure is a same predefined structure.

The spatial variation of laser process parameters in at least one of a z direction, an x,y direction and an x,y,z direction set such as to achieve (iii) a same predefined structure out of a plurality of predefined structures shall typically comprise that the respective spatial variation is set such as to achieve (iii) one same predefined structure or more same predefined structures each out of a plurality of predefined structures.

The spatial variation of laser process parameters may comprise a variation or modification of a setting of one laser process parameter or more laser process parameters in z direction to achieve (i) one predefined structure or (ii) a plurality of predefined structures or (iii) a same predefined structure out of a plurality of predefined structures of a digital twin of a coated spectacle lens. The spatial variation of laser process parameters comprises a variation of a setting of one or more laser process parameter(s) in z direction with respect to one discrete x,y position or with respect to more x,y positions to achieve (i) one predefined structure or (ii) a plurality of predefined structures or (iii) a same predefined structure out of a plurality of predefined structures of a digital twin of a coated spectacle lens. The more discrete x,y positions typically are directly adjacent to each other or neighbouring each other. The discrete x,y position defines a position of one predefined structure or a part of a same one predefined structure on a lens surface of the digital twin of the coated spectacle lens comprising the structure or the part of the structure. The discrete x,y positions define a domain of (i) one predefined structure or domains of (ii) a plurality of predefined structures on a lens surface of the digital twin of the coated spectacle lens comprising the structure(s).

Alternatively or additionally, the spatial variation of laser process parameters may comprise a variation or modification of a setting of one laser process parameter or more laser process parameters in x,y direction to achieve (i) one predefined structure or (ii) a plurality of predefined structures or (iii) a same predefined structure out of a plurality of predefined structures of a digital twin of a coated spectacle lens. The spatial variation of laser process parameters comprises a variation of a setting of one or more laser process parameter(s) in x,y direction with respect to discrete z positions to achieve (i) one predefined structure or (ii) a plurality of predefined structures or (iii) a same predefined structure out of a plurality of predefined structures of a digital twin of a coated spectacle lens. The discrete z positions typically are directly adjacent to each other or neighbouring each other. The discrete z positions are part of discrete x,y,z positions defining respective x,y positions on a lens surface of a digital twin of a coated spectacle lens comprising the (i) one predefined structure or (ii) the plurality of predefined structures or (iii) the same predefined structure out of the plurality of predefined structures.

In case laser process parameters comprise one set of predefined types of laser process parameters or more sets of predefined types of laser process parameters a setting of at least one laser process parameter thereof is determined such as to comprise at least one of a spatial variation in z direction and a spatial variation in x,y direction to achieve (i) one predefined structure or (ii) a plurality of predefined structures or (iii) a same predefined structure out of a plurality of predefined structures each of a digital twin of a coated spectacle lens.

In one set of predefined types of laser process parameters a setting of at least one laser process parameter may be determined such as to comprise a variation in z direction for one x,y position, a variation in more than one z direction for more x,y directions, or a variation in each z direction for more x,y directions to achieve (i) one predefined structure or (ii) a plurality of predefined structures or (iii) a same predefined structure out of a plurality of predefined structures each of a digital twin of a coated spectacle lens.

Alternatively or additionally to the variation in z direction, in one set of predefined types of laser process parameters a setting of at least one laser process parameter may be determined such as to comprise a variation in x,y direction to achieve (i) one predefined structure or (ii) a plurality of predefined structures or (iii) a same predefined structure out of a plurality of predefined structures each of a digital twin of a coated spectacle lens.

In case laser process parameters comprise more sets of predefined types of laser process parameters of which a setting of at least one laser process parameter is determined such as to comprise at least one of a spatial variation in z direction and a spatial variation in x,y direction to achieve (i) one predefined structure or (ii) a plurality of predefined structures or (iii) a same predefined structure out of a plurality of predefined structures each of a digital twin of a coated spectacle lens.

In an exemplary embodiment of the disclosure the method configured for designing a digital twin of a coated spectacle lens by means of a computer for the purpose of a use of the digital twin for manufacturing the coated spectacle lens comprises the step of
revising laser process parameters by manufacturing a coated spectacle lens
   to confirm the laser process parameters or
   to redetermine laser process parameters based on curing characteristics of a coating composition to achieve (i) one predefined structure or a (ii) plurality of predefined structures of a digital twin of the coated spectacle lens or a (iii) same structure out of a plurality of predefined structures.

Typically, the method configured for designing a digital twin of a coated spectacle lens by means of a computer for the purpose of a use of the digital twin for manufacturing the coated spectacle lens comprises the step of
revising laser process parameters by manufacturing the coated spectacle lens
   to confirm the laser process parameters or
   to redetermine laser process parameters based on curing characteristics to achieve the coated spectacle lens comprising (i) one structure corresponding to the (i) one predefined structure or a (ii) plurality of structures corresponding to the plurality of predefined structures or a (iii) same structure out of the plurality of structures corresponding to the same predefined structure out of the plurality of predefined structures.

“Revising” laser process parameters typically follow the step of determining laser process parameters to achieve (i) one predefined structure or (ii) a plurality of predefined structures of a digital twin a coated spectacle lens in that the digital twin is transferred to physical reality, a coated spectacle lens corresponding to the digital twin of the spectacle lens is manufactured. For revising laser process parameters, a step of determining laser process parameters to achieve a coated spectacle lens comprising (i) one structure or (ii) a plurality of structures corresponding to (i) one predefined structure or (ii) a plurality of predefined structures of a digital twin of the coated spectacle lens is followed by a step of manufacturing the coated spectacle lens. For revising laser process parameters, a step of determining laser process parameters to achieve a coated spectacle lens comprising (iii) a same out of a plurality of structures corresponding to (iii) a same predefined structure out of the plurality of predefined structures of a digital twin of the coated spectacle lens is followed by a step of manufacturing the coated spectacle lens. The manufacturing of the coated spectacle lens comprises at least the step of applying the determined laser process parameters to selectively cure a coating composition applied to a lens surface of a spectacle lens using laser radiation or a laser beam to result in a coated spectacle lens comprising (i) one structure or (ii) a plurality of structures or (iii) a same structure out of the plurality of structures.

In case the coated spectacle lens comprises (i) one structure or (ii) a plurality of structures corresponding to (i) one predefined structure or (ii) a plurality of predefined structures of a respective digital twin of the coated spectacle lens, then laser process parameters which had been determined with respect to the digital twin are confirmed. In case the coated spectacle lens comprises (iii) a same structure out of a plurality of structures corresponding to a same predefined structure out of the plurality of predefined structures of a respective digital twin of the coated spectacle lens, then laser process parameters which had been determined with respect to the digital twin are confirmed.

In case the coated spectacle lens comprises (i) one structure or (ii) a plurality of structures not corresponding to (i) one predefined structure or (ii) a plurality of predefined structures of a respective digital twin of the coated spectacle lens, then laser process parameters which had been determined with respect to the digital twin are redetermined. In case the coated spectacle lens comprises (iii) a same structure out of a plurality of structures not corresponding to a same predefined structure out of the plurality of predefined structures of a respective digital twin of the coated spectacle lens, then laser process parameters which had been determined with respect to the digital twin are redetermined.

The laser process parameters are redetermined based on curing characteristics of a coating composition to achieve the (i) one predefined structure or (ii) the plurality of predefined structures of the digital twin of the coated spectacle lens. The laser process parameters are redetermined based on curing characteristics of a coating composition to achieve the (iii) same predefined structure out of the plurality of predefined structures of the digital twin of the coated spectacle lens. If necessary, laser process parameters are redetermined until the coated spectacle lens comprises (i) one structure or (ii) a plurality of structures corresponding to (i) one predefined structure or (ii) a plurality of predefined structures of the digital twin of the coated spectacle lens. If necessary, laser process parameters are redetermined until the coated spectacle lens comprises (iii) a same structure out of a plurality of structures corresponding to (iii) a same predefined structure out of a plurality of predefined structures of the digital twin of the coated spectacle lens. When redetermining laser process parameters a result of the application of the determined laser process parameters to selectively cure the coating composition typically is taken into account. Redetermining laser process parameters includes amending or adapting determined laser process parameters.

The step of redetermining the laser process parameters taking the result of the application of the determined laser process parameters into account, may be followed by a step of applying the redetermined laser process parameters, followed by a step of again redetermining the laser process parameters taking the result of the application of the redetermined laser process parameters into account, and so on, end when with the redetermined or again redetermined laser process parameters (i) one predefined structure or (ii) a plurality of predefined structure or (iii) a same structure out of a plurality of structures is/are achievable or achieved.

Revising laser process parameters is comprised in a method configured for designing a digital twin of a coated spectacle lens by means of a computer thereby considering a result of applied determined laser process parameters, if necessary, once or more than once.

In an exemplary embodiment of the disclosure, the method configured for designing a digital twin of a coated spectacle lens by means of a computer for the purpose of a use of the digital twin for manufacturing the coated spectacle lens comprises the step of
determining laser process parameters such as to stepwise achieve at least one of
   (i) one predefined structure,
   a (ii) plurality of predefined structures,
   (iii) a same predefined structure out of a plurality of predefined structures.

To “stepwise” achieve (i) one predefined structure or (ii) a plurality of predefined structures or (iii) a same predefined structure out of a plurality of predefined structures each of a digital twin of a coated spectacle lens shall comprise that one laser process parameter or more laser process parameters is/are determined in a predefined sequence to achieve the (i) one predefined structure or the (ii) plurality of predefined structures or (iii) the same predefined structure out of the plurality of predefined structures. One laser process parameter is determined in a predefined sequence if a setting of the one laser process parameter is modified in a predefined sequence. More laser process parameters are determined in a predefined sequence if in a predefined sequence a setting of different laser process parameters is modified.

To stepwise achieve the (i) one predefined structure of the digital twin a setting of at least one laser process parameter is determined in a predefined sequence to achieve (i) one same predefined structure. To achieve the (i) one same predefined structure the setting of the at least one laser process parameter typically is determined such as to achieve the (i) one same structure in the predefined sequence in one position or in one domain of a lens surface of the digital twin.

To stepwise achieve the (ii) plurality of predefined structures of the digital twin a setting of at least one laser process parameter is determined in a predefined sequence to achieve the (ii) plurality of predefined structures. To achieve the (ii) plurality of predefined structures the setting of the at least one laser process parameter typically is determined such as to achieve a plurality of structures each having a same structure in a predefined sequence in different positions or in different domains of a lens surface of the digital twin. Alternatively, to achieve the (ii) plurality of predefined structures a setting of at least one laser process parameter may be determined such as to achieve in a predefined sequence a plurality of structures not having a same structure in different positions or in different domains of a lens surface of a digital twin of a coated spectacle lens.

To stepwise achieve the (iii) same predefined structure out of a plurality of predefined structures a setting of at least one laser process parameter is determined in a predefined sequence to achieve the (iii) same predefined structure out of the plurality of predefined structures. The same structure may comprise one same predefined structure out of the plurality of structures or more same predefined structures out of the plurality of structures. To achieve the one same predefined structure the setting of the at least one laser process parameter is determined such as to achieve the one same structure in a predefined sequence in one position or in one domain of a lens surface of the digital twin. To achieve the more same predefined structures the setting of the at least one laser process parameter typically is determined such as to achieve a respective same structure of the more same structures in a predefined sequence in different positions or in different domains of a lens surface of the digital twin.

The laser process parameters may comprise one set of predefined types of laser process parameters or more sets of predefined laser process parameters to stepwise achieve the (i) one predefined structure or the (ii) plurality of predefined structures or the (iii) same structure out of a plurality of predefined structures of the digital twin.

In the one set of predefined types of laser process parameters, a setting of one laser process parameter or a setting of more laser process parameters may be determined in a predefined sequence to achieve (i) one same predefined structure or a (ii) plurality of predefined same structures or a (iii) same structure out of a plurality of predefined structures. Determining laser process parameters in a predefined sequence may also comprise a determination of one set of predefined types of laser process parameters in which a setting of at least one laser process parameter is determined to achieve the (i) one same predefined structure or the (ii) plurality of same predefined structures or the (iii) same predefined structure out of the plurality of predefined structures.

In the more sets of predefined types of laser process parameters, a setting of one laser process parameter or a setting of more laser process parameters in each set thereof may be determined in a predefined sequence to achieve (i) one same predefined structure or a (ii) plurality of predefined same structures or a (iii) same structure out of a plurality of predefined structures.

The more sets of predefined types of laser process parameters may comprise
a first set of predefined types of laser process parameters in which a first setting of at least one laser process parameter, e.g., a first laser process parameter, is determined;
a second set of predefined types of laser process parameters in which a second setting of a same laser process parameter, e.g., a second setting of the first laser process parameter, or a first setting of a different laser process parameter, e.g., a first setting of a second laser process parameter, is determined;
optionally a third set of predefined types of laser process parameters in which a third setting of a same laser process parameters, e.g., a third setting of the first laser process parameter or a second setting of the second laser process parameter, or a first setting of an again different laser process parameter, e.g., a first setting of a fourth laser process parameter, is determined.

For each optional further set of the more sets of predefined types of laser process parameters at least a setting of at least one laser process parameter is determined.

In the one set or in the more sets of laser process parameters a setting of one laser process parameter or a setting of more laser process parameters is determined in a predefined sequence such as to achieve stepwise, these settings taken together, the same (i) one predefined structure or the (ii) plurality of same predefined structures or the (iii) same predefined structure out of the plurality of predefined structures of the digital twin.

Determining laser process parameters in a predefined sequence may also comprise a determination of one set or more sets of predefined types of laser process parameters in which in each set a setting of at least one process parameter is determined such as to achieve the (i) one same predefined structure or the (ii) plurality of predefined structures or the (iii) same predefined structure out of the plurality of predefined structures. The determined laser process parameters are determined in a predefined sequence such as to achieve altogether the same (i) one predefined structure or the (ii) plurality of same predefined structures or the (iii) same predefined structure out of the plurality of predefined structures.

In an exemplary embodiment of the disclosure, the method comprises the step of manufacturing a coated spectacle lens based on a designed digital twin of the coated spectacle lens.

The method is configured for manufacturing a coated spectacle lens based on a designed digital twin of the coated spectacle lens.

The problem has been solved by the method of manufacturing the coated spectacle lens. With the before described method a digital twin of a coated spectacle lens is transferred to physical reality, i.e., a respective coated spectacle lens which comprises any one of the before mentioned structures or any arbitrary structure is manufactured. The coated spectacle lens may comprise (i) one structure or a (ii) plurality of structures designed such as to be suitable for being used in prevention or control of myopia or hyperopia progression.

In an exemplary embodiment of the disclosure, the manufacturing comprises the step of
selectively curing a coating composition by applying determined laser process parameters to achieve (i) one structure or a (ii) plurality of structures corresponding to the (i) one predefined structure or the (ii) plurality of predefined structures.

The method configured for manufacturing a coated spectacle lens is characterized at least in the step of selectively curing a coating composition by applying determined laser process parameters.

A surface layer of a coated spectacle lens forming or causing (i) one structure or (ii) a plurality of structures typically requires at least the manufacturing step of:
selectively curing a coating composition using laser radiation or a laser beam by applying determined laser process parameters.

A surface layer may comprise one surface layer, accordingly a coating composition may comprise one coating composition resulting in the one surface layer; or more surface layers, accordingly a coating composition may comprise more coating compositions resulting in the more surface layers.

One surface layer of a coated spectacle lens forming or causing (i) one structure or (ii) a plurality of structures typically requires at least the manufacturing step of:
selectively curing one coating composition using laser radiation or a laser beam by applying determined laser process parameters.

As described before the laser process parameters are determined such that one surface layer of the coated spectacle lens resulting from the selectively cured one coating composition comprises the (i) one structure or the (ii) plurality of structures corresponding to (i) one predefined structure or (ii) a plurality of predefined structures of a digital twin of the coated spectacle lens. The determined laser process parameters are thereby considering curing characteristics of the one coating composition.

Typically, the one coating composition is applied to a front surface, a back surface or to a front and back surface of a spectacle lens. The front surface or the back surface of the spectacle lens may already comprise one surface layer or more surface layers. Typically, the one coating composition is applied to fully cover the front surface and/or the back surface of the spectacle lens. The coating composition may be applied for example by dip coating, spin coating or inkjet printing, typically spin coating. The definition of “selectively curing” as well as for “applied to fully cover,” both given before, shall apply.

The one coating composition is
selectively cured to result, at least with respect to a selectively cured part of the one coating composition, in one surface layer forming or causing the (i) one structure or the (ii) plurality of structures of the coated spectacle lens. The not cured part of the one coating composition may be removed.

Typically, one surface layer of a coated spectacle lens forming or causing (i) one structure or (ii) a plurality of structures corresponding to (i) one predefined structure or (ii) a plurality of predefined structures of a digital twin of the coated spectacle lens requires at least the manufacturing steps of
a) applying the one coating composition to fully cover a front surface and/or to fully cover a back surface of a spectacle lens, typically the front surface,
b) selectively curing the one coating composition using laser radiation or a laser beam by applying the determined laser process parameters,
c) removing not cured coating composition from the front surface and/or the back surface.

The selectively cured one coating composition of step b) forms one surface layer of a coated spectacle lens, the one surface layer forming or causing (i) one structure or (ii) a plurality of structures. Even though the not cured coating composition is removed in step c) and thus the one surface layer resulting in step b) is not completely covering the front surface and/or the back surface of the spectacle lens, as the case may have been when applying the one coating composition in step a), the selectively cured coating composition shall be regarded as one surface layer.

The one coating composition typically is at least one selected from the group consisting of
one UV curable coating composition curable by a selected wavelength of laser radiation or a laser beam resulting in one surface layer,
one primer hard coating composition resulting in one primer surface layer for a hard coating,
one primer photochromic coating composition resulting in one primer surface layer for a photochromic surface layer,
one hard coating composition resulting in one hard coating surface layer, hard coating as defined in ISO 13666:2019(E), section 3.18.2,
one photochromic coating composition resulting in one photochromic surface layer.

The one coating composition may be a clear coating composition, clear in the sense of “clear lens” defined in ISO 13666:2019(E), section 3.5.7, the clear coating composition having no intended colour/tint in transmission. The one coating composition typically is a clear coating composition. Alternatively, the one coating composition may be a tinted coating composition, tinted in the sense of “tinted lens” defined in ISO 13666:2019(E), section 3.5.6, the tinted coating composition having a noticeable colour (including grey) in transmission.

The one coating composition may result in one surface layer provided anyway in the coated spectacle lens or in one additional surface layer of the coated spectacle lens. In case the one surface layer is provided anyway in the coated spectacle lens no additional surface layer for forming or causing (i) one structure or (ii) a plurality of structures corresponding to (i) one predefined structure or (ii) a plurality of predefined structures of a respective digital twin of the coated spectacle lens is necessary. The one surface layer itself fulfils a double function of on the one hand being responsible for forming or causing the (i) one structure or the (ii) plurality of structures of the coated spectacle lens and on the other to fulfil its function. To fulfil its function shall comprise to serve a purpose for which the surface layer is comprised in the coated spectacle lens. An additional benefit of the one surface layer provided anyway in the coated spectacle lens is that no additional process time for an application of one coating composition resulting in the one surface layer is required as the one coating composition is anyway applied.

In case the one additional surface layer is comprised in the coated spectacle lens only for the reason of forming or causing the (i) one structure or the (ii) plurality of structures, the one additional surface layer typically does neither serve a further purpose nor interferes with an adjacent surface layer nor is detrimental with respect to a characteristic of the coated spectacle lens. The characteristic may be an optical property of the coated spectacle lens, like yellowing, or a mechanical property, like delamination. The one additional surface layer typically is selected in that a minimum of process time is lost due to an application of one additional coating composition resulting in the additional surface layer.

More surface layers of a coated spectacle lens forming or causing (i) one structure or (ii) a plurality of structures typically require at least the manufacturing step of
selectively curing more coating compositions using laser radiation or a laser beam by applying determined laser process parameters.

The laser process parameters are determined such that more surface layers of the coated spectacle lens resulting from the more coating compositions comprises the (i) one structure or the (ii) plurality of structures corresponding to (i) one predefined structure or (ii) a plurality of predefined structures of a digital twin of the coated spectacle lens. The laser process parameters are determined considering curing characteristics of the coating compositions.

Typically, the coating compositions are applied as a stack to a front surface, a back surface or as a stack to each of a front and back surface of a spectacle lens. The front surface or the back surface may already comprise one surface layer or more surface layers. Typically, the coating compositions are applied to fully cover the front surface and/or the back surface of the spectacle lens. The coating compositions may be applied subsequently by dip coating, spin coating or inkjet printing, typically spin coating. The definition of “selectively curing” as well as for “applied to fully cover,” both given before, shall apply. Subsequently applying the coating composition may comprise a drying of a coating composition before a next or subsequent coating composition is applied.

The coating compositions are
selectively cured simultaneously to result, with respect to a simultaneously selectively cured part of the coating compositions, in more surface layers forming or causing the (i) one structure or the (ii) plurality of structures of the coated spectacle lens. The not cured part of the coating compositions may be removed.

Typically, more surface layers of a coated spectacle lens forming or causing (i) one structure or (ii) a plurality of structures corresponding to (i) one predefined structure or (ii) a plurality of predefined structures of a digital twin of the coated spectacle lens require at least the manufacturing steps of
a) applying the coating compositions, typically as a stack, to fully cover a front surface and/or to fully cover a back surface of a spectacle lens, typically the front surface,
b) selectively curing simultaneously the coating compositions using laser radiation or a laser beam by applying determined laser process parameters,
c) removing not cured coating compositions from the front surface and/or the back surface.

The selectively cured coating compositions of step b) form more surface layers of a coated spectacle lens, the more surface more layers forming or causing (i) one structure or (ii) a plurality of structures corresponding to (i) one predefined structure or (ii) a plurality of predefined structures of a respective digital twin of the coated spectacle lens. Even though the not cured coating compositions are removed in step c) and thus the more surface layers resulting in step b) are not completely covering the front surface and/or the back surface of the spectacle lens, as the case may have been when applying the coating compositions in step a), remaining selectively cured coating compositions shall be regarded as more surface layers.

The more coating compositions may be selected from the following coating compositions:

a UV curable coating composition curable by a selected wavelength of laser radiation or a laser beam, a primer hard coating composition, a primer photochromic coating composition, a hard coating composition, a photochromic coating composition.

The more coating compositions may be composed of a same coating composition or a different coating composition. Typically, the same coating composition comprises identical chemical ingredients, either in identical amounts or in different amounts.

The more coating compositions typically comprise clear coating compositions only. However, at least one of the more coating compositions may be a tinted coating composition.

The more coating compositions may result in more surface layers provided anyway in the coated spectacle lens, in part provided anyway in the coated spectacle lens, or in more additional surface layers of the coated spectacle lens. In case the more surface layer are provided anyway in the coated spectacle lens no additional surface layer or no additional surface layers is/are necessary for forming or causing the (i) one structure or the (ii) plurality of structures corresponding to the (i) one predefined structure or the (ii) plurality of predefined structures of the respective digital twin of the coated spectacle lens. The more surface layers themselves fulfil each a double function of on the one hand being responsible for forming or causing the (i) one structure or the (ii) plurality of structures of the coated spectacle lens and on the other to fulfil their respective function. To fulfil their respective function shall comprise to serve a respective purpose for which a respective surface layer is comprised in the coated spectacle lens. An additional benefit of the more surface layers provided anyway in the coated spectacle lens is that no additional process time for an application of more coating compositions resulting in the more surface layers is required as the more coating compositions are anyway applied.

In case the more surface layers are provided in part anyway in the coated spectacle lens, in the part no additional surface layer(s) is/are necessary for forming or causing the (i) one structure or (ii) the plurality of structures. For the part of the more surface layers the before described applies. For a part of the more surface layers not provided anyway in the coated spectacle lens, the hereinafter described with respect to the more additional surface layers applies.

In case the more additional surface layers are comprised in the coated spectacle lens only for the reason of forming or causing the (i) one structure or the (ii) plurality of structures, the more additional surface layers typically do neither serve a further purpose nor interfere with an adjacent surface layer nor are detrimental with respect to a characteristic of the coated spectacle lens. The more additional layers typically are selected in that a minimum of process time is lost due to an application of more additional coating compositions resulting in the additional surface layers.

Therefore, more surface layers provided anyway, or more surface layer provided anyway in part in the coated spectacle lens are typical.

Optionally, more surface layers of a coated spectacle lens forming or causing the (i) one structure or the (ii) plurality of structures corresponding to the (i) one predefined structure or the (ii) plurality of predefined structures of the respective digital twin of the spectacle lens, for example as described before, may comprise an additional step of
applying one additional coating composition or more additional coating compositions.

The one additional coating composition results in one additional surface layer covering the more surface layers resulting from the selectively cured more coating compositions and a lens surface of a spectacle lens, i.e., either a front surface or a back surface of the spectacle lens, comprising the more surface layers. The one additional coating composition typically is applied via spin coating, dip coating or inkjet printing, typically spin coating. The one additional coating composition typically is selected from a hard coating composition and a photochromic coating composition.

The more additional coating compositions result in more additional surface layers, the first thereof covering the more surface layers resulting from the selectively cured more coating compositions and a lens surface of a spectacle lens, i.e., a front surface or a back surface of the spectacle lens, comprising the more surface layers. The more additional coating compositions or at least a part of the more additional coating compositions may be applied subsequently via spin coating, dip coating or inkjet printing, typically spin coating. The more additional coating compositions may comprise hard coating composition or a photochromic coating composition. The more additional surface layers may further comprise an anti-reflective coating as defined in ISO 13666:2019(E), section 3.18.3, a clean coating as defined in ISO 13666:2019(E), section 3.18.4, a hydrophobic coating as defined in ISO 13666:2019(E), section 3.18.5, a hydrophilic coating as defined in ISO 13666:2019(E), section 3.18.6, an anti-fog coating as defined in ISO 13666:2019(E), section 3.18.7, an anti-static coating as defined in ISO 13666:2019(E), section 3.18.8. The more additional surface layers may also be applied via physical vapour deposition.

The laser process parameters typically are determined such that the more surface layers resulting from the selectively cured more coating compositions and the one additional surface layer resulting form the one additional coating composition; or the more surface layers resulting from the selectively cured more coating compositions and the more additional surface layers resulting form the more additional coating compositions together form or cause the (i) one structure or the (i) plurality of structures of the coated spectacle lens.

Alternatively, more surface layers of a coated spectacle lens forming or causing (i) one structure or (ii) a plurality of structures typically require at least the manufacturing steps of
selectively curing a first coating composition using laser radiation or a laser beam by applying determined laser process parameters,
applying a second coating composition.

The laser process parameters are determined such that a first surface layer of the coated spectacle lens resulting from the selectively cured first coating composition and a second surface layer of the coated spectacle lens resulting from the second coating composition together form or cause (i) one structure or (ii) a plurality of structures corresponding to (i) one predefined structure or (ii) a plurality of predefined structures of a digital twin of the coated spectacle lens. The laser process parameters are thereby considering curing characteristics of the first coating composition.

Optionally, more surface layers of a coated spectacle lens forming or causing (i) one structure or (ii) a plurality of structures may require an additional manufacturing step of
applying a third coating composition.

The laser process parameters are determined such that a first surface layer of the coated spectacle lens resulting from the selectively cured first coating composition, a second surface layer of the coated spectacle lens resulting form the second coating composition and a third surface layer of the coated spectacle lens resulting from the third coating composition together form or cause (i) one structure or (ii) a plurality of structures of the coated spectacle lens corresponding to (i) one predefined structure or (ii) a plurality of predefined structures of a digital twin of the coated spectacle lens. The laser process parameters are thereby considering curing characteristics of the first coating composition. In case the coated spectacle lens comprises more than the three surface layers, the laser process parameters are determined such that the first surface layer of the coated spectacle lens resulting from the selectively cured first coating composition and the second, third, fourth and each further surface layer of the coated spectacle lens resulting from the second, third, fourth and each further coating composition together form or cause (i) one structure or (ii) a plurality of structures of the coated spectacle lens corresponding to (i) one predefined structure or (ii) a plurality of predefined structures of a digital twin of the coated spectacle lens. The laser process parameters are thereby considering curing characteristics of the first coating composition.

In a surface layer sequence of a coated spectacle lens, the first surface layer is a surface layer next, not necessarily adjacent, to a front surface and/or a back surface of a spectacle lens and the second surface layer is a surface layer further away from a same front surface and/or a same back surface of the spectacle lens. An optional third surface layer and each optional further surface layer is a surface layer further away from a same front surface and/or a same back surface of the spectacle lens as the the second surface layer.

Typically, the first coating composition is applied to a front surface, a back surface or to a front and back surface of a spectacle lens. The front surface or the back surface may already comprise one or more surface layer(s). Typically, the first coating composition is applied to fully cover the front surface and/or the back surface of the spectacle lens. The first coating composition may be applied for example by dip coating, spin coating, or inkjet printing, typically spin coating. The definition of “selectively curing” as well as for “applied to fully cover,” both given before, shall apply.

The second coating composition may be applied for example by dip coating, spin coating, or inkjet printing, typically spin coating or dip coating, typically to fully cover the first surface layer resulting from selectively curing the first coating composition and a front surface comprising the first surface layer; and/or typically to fully cover the first surface layer resulting from selectively curing the first coating composition and a back surface comprising the first surface layer. An optional third coating composition and each optional further coating composition may be applied for example by dip coating, spin coating, or ink jet printing, typically to fully cover the second surface layer resulting from the second coating composition. An optional third surface layer or an optional further surface layer may result from a third optional or further optional coating composition applied for example by dip coating, spin coating, or inkjet printing, typically spin coating or dip coating, or may comprise a layer stack applied via physical vapour deposition, each to cover a respective surface layer underneath typically fully.

The first coating composition is
selectively cured to result, with respect to a selectively cured part of the first coating composition, in a first surface layer. The not cured part of the first coating composition may be removed.

Typically, more surface layers of a coated spectacle lens forming or causing (i) one structure or (ii) a plurality of structures corresponding to (i) one predefined structure or (ii) a plurality of predefined structures of a digital twin of the coated spectacle lens require at least the manufacturing steps of
a) applying a first coating composition to fully cover a front surface and/or to fully cover a back surface of a spectacle lens, typically the front surface,
b) selectively curing the first coating composition using laser radiation or a laser beam by applying determined laser process parameters,
c) removing not cured first coating composition from the front surface and/or the back surface,
d) applying a second coating composition,
e) curing the second coating composition.
   The selectively cured first coating composition of step b) forms a first surface layer of a coated spectacle lens. Even though the not cured coating composition is removed in step c) and thus the first surface layer resulting in step b) is not completely covering the front surface and/or the back surface of the spectacle lens, as the case may have been when applying the first coating composition in step a), the selectively cured first coating composition shall be regarded as first surface layer. As the not cured first coating composition is removed in step c) the second coating composition is applied to the first surface layer and the front surface and/or the back surface comprising the first surface layer. A second coating composition may also be applied to a front surface or back surface of a spectacle lens not comprising the first surface layer. Typically, the second coating composition is applied to completely cover the front surface and/or the back surface comprising the first surface layer and optionally to completely cover a front surface or a back surface not comprising the first surface layer. After curing step e) the second coating composition results in a second surface layer. The first surface layer and the second surface layer are forming or causing (i) one structure or (ii) a plurality of structures corresponding to (i) one predefined structure or (ii) a plurality of predefined structures of a digital twin of the coated spectacle lens.

The first coating composition and the second composition may be composed of a same coating composition. Typically, the same coating composition comprises identical chemical ingredients, either in identical amounts or in different amounts. A first surface layer resulting from the first coating composition and a second surface layer resulting from the second coating composition differ in that the first surface layer is covering a front surface and/or a back surface of a spectacle lens only in at least one of
in a position or in positions and
within a domain or domains,
   in which the first coating composition had been selectively cured, as explained before, whereas the second surface layer is completely covering at least a same front surface comprising the first surface layer and/or a same back surface comprising the first surface layer. The second surface layer typically covers the first surface layer and a same front surface comprising the first surface layer; and/or the first surface layer and a same back surface comprising the first surface layer. The second surface layer may also completely cover a front surface and/or a back surface which is not comprising the first surface layer.

In case the first coating composition and the second coating composition are composed of a same coating composition, the same coating composition typically is at least one selected from the group consisting of
a UV curable coating composition curable by a selected wavelength of laser radiation or a laser beam resulting in a surface layer,
a primer hard coating composition resulting in a primer surface layer for a hard coating,
a primer photochromic coating composition resulting in a primer surface layer for a photochromic surface layer,
a hard coating composition resulting in a hard coating as defined in ISO 13666:2019(E), section 3.18.2,
a photochromic coating composition resulting in a photochromic surface layer.

The same coating composition may be clear or tinted, typically clear.

The first coating composition and the second coating composition may be composed of a different coating composition. A first surface layer resulting from the first coating composition and a second surface layer resulting from the second coating composition therefore not only differ in their spatial coverage of a same front surface and/or a same back surface of a spectacle lens. The first surface layer covers a front surface and/or a back surface of a spectacle lens only in at least one of
in a position or in positions and
within a domain or within domains
   in which the first coating composition had been selectively cured while the second surface layer at least completely covers a same front surface and/or a same back surface comprising the first surface layer. The second surface layer typically covers the first surface layer and a same front surface comprising the first surface layer; and/or the first surface layer and a same back surface comprising the first surface layer. The second surface layer may also completely cover a front surface and/or a back surface of a spectacle lens not comprising the first surface layer.

An optional third coating composition typically is composed of a different coating composition to the same first and second coating compositions. A resulting third surface layer typically covers the second surface layer.

In case the first coating composition and the second coating composition are composed of a different coating composition, the first coating composition typically is at least one selected from of the group consisting of
a first UV curable coating composition curable by a selected wavelength of laser radiation or a laser beam resulting in a first surface layer,
a first primer hard coating composition resulting in a first primer surface layer for a hard coating,
a first primer photochromic coating composition resulting in a first primer surface layer for a photochromic surface layer,
a first hard coating composition resulting in a first hard coating as defined in ISO 13666:2019(E), section 3.18.2,
a first photochromic coating composition resulting in a first photochromic surface layer.

The first coating composition may be clear or tinted, typically clear.

The second coating composition typically is at least one selected from the group consisting of
a second UV curable coating composition curable by a selected wavelength of laser radiation or a laser beam resulting in a second surface layer,
a second primer hard coating composition resulting in a second primer surface layer for a hard coating,
a second primer photochromic coating composition resulting in a second primer surface layer for a photochromic surface layer,
a second hard coating composition resulting in a second hard coating as defined in ISO 13666:2019(E), section 3.18.2,
a second photochromic coating composition resulting in a second photochromic surface layer.

The second coating composition may be clear or tinted, typically clear.

An optional third coating composition may be composed of a same coating composition as the first coating composition or as the second coating composition. Typically, the optional third coating composition is composed of a different coating composition to the first coating composition and to the second coating composition. An optional third surface layer resulting from the third coating composition typically covers the second surface layer.

Typically, the first coating composition, typically selected from one of the before mentioned, and the second coating composition, typically selected from one of the before mentioned, are selected such that at least one surface layer resulting from a coating composition thereof is anyway part of a surface layer sequence of a coated spectacle lens. For example, if the surface layer sequence of the coated spectacle lens comprises a hard coating, then typically the second coating composition is selected from a second hard coating composition.

Typically, the first coating composition, typically selected from one of the before mentioned, and the second coating composition, typically selected from one of the before mentioned, are selected such that both surface layers resulting from the coating compositions anyway are part of a surface layer sequence of a coated spectacle lens. For example, if the surface layer sequence of the coated spectacle lens comprises a first hard coating and a second hard coating, then typically the first coating composition is selected from a first hard coating composition and the second coating composition is selected from a second hard coating composition. The first hard coating typically is a surface layer next to, but not necessarily directly adjacent, to a front surface or a back surface of a spectacle lens.

Irrespective of whether the first coating composition and the second coating composition being composed of a same or a different coating composition, at least one of a first surface layer or a second surface layer provided anyway in a coated spectacle lens has the additional benefit as outlined before.

An optional third coating composition typically is composed of a different coating composition to the first coating composition and second coating composition. A resulting third surface layer typically covers the second surface layer.

More surface layers of a coated spectacle lens forming or causing (i) one structure or (ii) a plurality of structures corresponding to (i) one predefined structure or (ii) a plurality of predefined structures of a digital twin of the coated spectacle lens, may require the manufacturing steps of
a) applying a first coating composition to fully cover a front surface and/or a back surface of a spectacle lens, typically to fully cover the front surface,
b) precuring the first coating composition using laser radiation or a laser beam by applying determined laser parameters,
c) removing not precured first coating composition,
d) applying a second coating composition,
e) curing the second coating composition.

The front surface of the spectacle lens to which the first coating composition is applied to in step a) may already comprise one surface layer or more surface layers. The same applies to the back surface of the spectacle lens. In step b) the first coating composition is precured typically to an extend that the precured first coating composition is not removed in step c). The second coating composition typically is applied to completely cover the precured first coating composition and a front surface comprising the precured first coating composition and/or to completely cover the precured first coating composition and a back surface comprising the precured first coating composition in step d). The second coating composition also may be applied to completely cover a front surface or a back surface of a spectacle lens not comprising the precured first coating composition. Curing the second coating composition in step e) typically is simultaneously curing the precured first coating composition. Typically, while curing the second coating composition in step e) the precured first coating composition is simultaneously cured, irrespective of whether the first coating composition and the second coating composition are composed of a same or a different coating composition.

Alternatively, more surface layers of a coated spectacle lens forming or causing (i) one structure or (ii) a plurality of structures typically require at least the manufacturing steps of
selectively curing a first coating composition using laser radiation or a laser beam by applying determined laser process parameters,
applying a second coating composition,
selectively curing a third coating composition using laser radiation or a laser beam by applying determined laser process parameters.

The laser process parameters are determined such that a first surface layer of the coated spectacle lens resulting from the selectively cured first coating composition, a second surface layer of the coated spectacle lens resulting from the second coating composition and a third coating composition resulting from the selectively cured third coating composition together form or cause (i) one structure or (ii) a plurality of structures corresponding to (i) one predefined structure or (ii) a plurality of predefined structures of a digital twin of the coated spectacle lens. The laser process parameters are thereby considering curing characteristics of the first coating composition as well as curing characteristics of the third coating composition.

Optionally, more surface layers of a coated spectacle lens forming or causing (i) one structure or (ii) a plurality of structures may require an additional manufacturing step of
applying a fourth coating composition.

The laser process parameters are determined such that a first surface layer of the coated spectacle lens resulting from the selectively cured first coating composition, a second surface layer of the coated spectacle lens resulting form the second coating composition, a third surface layer of the coated spectacle lens resulting from the selectively cured third coating composition and a fourth surface layer resulting from the fourth coating composition together form or cause (i) one structure or (ii) a plurality of structures corresponding to (i) one predefined structure or (ii) a plurality of predefined structures of a digital twin of the coated spectacle lens. The laser process parameters are thereby considering curing characteristics of the first coating composition and the third coating composition. In case the coated spectacle lens comprises more than four surface layers, the laser process parameters are determined such that the first surface layer of the coated spectacle lens resulting from the selectively cured first coating composition, the second surface layer resulting from the second coating composition, the third surface layer resulting from the selectively cured third coating composition, the fourth and each further surface layer resulting from the fourth and each further coating composition together form or cause (i) one structure or (ii) a plurality of structures of the coated spectacle lens corresponding to (i) one predefined structure or (ii) a plurality of predefined structures of a digital twin of the coated spectacle lens. The laser process parameters are thereby considering curing characteristics of the first and third coating composition.

In a surface layer sequence of a coated spectacle lens, the first surface layer is a surface layer next, not necessarily adjacent, to a front surface and/or a back surface of a spectacle lens and the third surface layer is a surface layer furthest away from a same front surface and/or a same back surface of the spectacle lens. An optional fourth surface layer and each optional further surface layer is a surface layer further away from a same front surface and/or a same back surface of the spectacle lens as the the third surface layer.

Typically, the first coating composition is applied to a front surface, a back surface or to a front and back surface of a spectacle lens. The front surface or the back surface may already comprise one or more surface layer(s). Typically, the first coating composition is applied to fully cover the front surface and/or the back surface of the spectacle lens. The first coating composition may be applied for example by dip coating, spin coating, or inkjet printing, typically spin coating. The definition of “selectively curing” as well as for “applied to fully cover,” both given before, shall apply.

The second coating composition may be applied for example by dip coating, spin coating, or inkjet printing, typically spin coating or dip coating, typically to fully cover the first surface layer resulting from selectively curing the first coating composition and a front surface comprising the first surface layer; and/or typically to fully cover the first surface layer resulting from selectively curing the first coating composition and a back surface comprising the first surface layer.

The third coating composition may be applied for example by dip coating, spin coating, or inkjet printing, typically spin coating or dip coating, typically to fully cover the second surface layer resulting from the second coating composition. An optional fourth surface layer or an optional further surface layer may comprise a fourth or further coating composition applied for example by dip coating, spin coating, or inkjet printing, typically spin coating or dip coating, or a layer stack applied via physical vapour deposition, each to fully cover a respective surface layer underneath.

The first coating composition is
selectively cured to result, with respect to a selectively cured part of the first coating composition, in a first surface layer. The not cured part of the first coating composition may be removed.

The third coating composition is
selectively cured to result, with respect to a selectively cured part of the third coating composition, in a third surface layer. The not cured part of the first coating composition may be removed.

Typically, more surface layers of a coated spectacle lens forming or causing (i) one structure or (ii) a plurality of structures corresponding to (i) one predefined structure or (ii) a plurality of predefined structures of a digital twin of the coated spectacle lens require at least the manufacturing steps of
a) applying a first coating composition to fully cover a front surface and/or to fully cover a back surface of a spectacle lens, typically the front surface,
b) selectively curing the first coating composition using laser radiation or a laser beam by applying determined laser process parameters,
c) removing not cured first coating composition from the front surface and/or the back surface,
d) applying a second coating composition,
e) curing the second coating composition,
f) applying a third coating composition,
g) selectively curing the third coating composition using laser radiation or a laser beam by applying determined laser process parameters,
h) removing not cured third coating composition.

The selectively cured first coating composition of step b) forms a first surface layer of a coated spectacle lens. Even though the not cured coating composition is removed in step c) and thus the first surface layer resulting in step b) is not completely covering the front surface and/or the back surface of the spectacle lens, as the case may have been when applying the first coating composition in step a), the selectively cured first coating composition shall be regarded as first surface layer. As the not cured first coating composition is removed in step c) the second coating composition is applied to the first surface layer and the front surface and/or the back surface comprising the first surface layer. A second coating composition may also be applied to a front surface or back surface of a spectacle lens not comprising the first surface layer. Typically, the second coating composition is applied to completely cover the front surface and/or the back surface comprising the first surface layer and optionally to completely cover a front surface or a back surface not comprising the first surface layer. After curing step e) the second coating composition results in a second surface layer. A third coating composition is applied in step f) to fully cover the second surface layer. In case a second surface layer covers the first surface layer on for example the front surface and is also comprised on for example the back surface of the spectacle lens, the third coating composition is applied to fully cover at least the second surface layer covering the first surface layer. The third coating composition typically is applied in step f) to fully cover the second surface layer covering the first surface layer. The selectively cured third coating composition of step g) forms a third surface layer of the coated spectacle lens. Even though the not cured coating composition is removed in step h) and thus the third surface layer resulting in step g) is not completely covering the second surface layer, the selectively cured third coating composition shall be regarded as third surface layer. In case of the first, the second and the third surface layer being on a same lens surface of the coated spectacle lens, the first, second and third surface layer together are forming or causing (i) one structure or (ii) a plurality of structures corresponding to (i) one predefined structure or (ii) a plurality of predefined structures of a digital twin of the coated spectacle lens. In case the first surface layer and the second surface layer are on a same lens surface of the coated spectacle lens while a further second surface layer and the third surface layer are on the other lens surface thereof, the first and the second surface layer together are forming or causing (i) one structure or (ii) a plurality of structures corresponding to (i) one predefined structure or (ii) a plurality of predefined structures of a digital twin of the coated spectacle lens and the further second surface layer and the third surface layer together are forming or causing (i) one structure or (ii) a plurality of structures corresponding to (i) one predefined structure or (ii) a plurality of predefined structures of a digital twin of the coated spectacle lens.

As described before the first and second coating composition may be composed of a same or a different coating composition. Reference is made to the above explanations.

Alternatively, more surface layers of a coated spectacle lens forming or causing (i) one structure or (ii) a plurality of structures typically require at least the manufacturing steps of
selectively curing a first coating composition using laser radiation or a laser beam by applying determined laser process parameters,
selectively curing a second coating composition using laser radiation or a laser beam by applying determined laser process parameters.

The laser process parameters are determined such that a first surface layer of the coated spectacle lens resulting from the selectively cured first coating composition and a second surface layer of the coated spectacle lens resulting from the second coating composition together form or cause (i) one structure or (ii) a plurality of structures corresponding to (i) one predefined structure or (ii) a plurality of predefined structures of a digital twin of the coated spectacle lens. The laser process parameters are thereby considering curing characteristics of the respective first coating composition and curing characteristics of the respective second coating composition.

Optionally, more surface layers of a coated spectacle lens forming or causing (i) one structure or (ii) a plurality of structures may require an additional manufacturing step of
applying a third coating composition.

The laser process parameters are determined such that a first surface layer of the coated spectacle lens resulting from the selectively cured first coating composition, a second surface layer of the coated spectacle lens resulting from the selectively cured second coating composition and a third surface layer resulting from the third coating composition together form or cause (i) one structure or (ii) a plurality of structures of the coated spectacle lens corresponding to (i) one predefined structure or (ii) a plurality of predefined structures of a digital twin of the coated spectacle lens. The laser process parameters are thereby considering curing characteristics of the first coating composition and the second coating composition.

In a surface layer sequence of a coated spectacle lens, the first surface layer is a surface layer next, not necessarily adjacent, to a front surface and/or a back surface of a spectacle lens and the second surface layer is a surface layer further away from a same front surface and/or a same back surface of the spectacle lens. An optional third surface layer and each optional further surface layer is a surface layer further away from a same front surface and/or a same back surface of the spectacle lens as the the second surface layer.

Typically, the first coating composition is applied to a front surface, a back surface or to a front and back surface of a spectacle lens. The front surface or the back surface may already comprise one or more surface layer(s). Typically, the first coating composition is applied to fully cover the front surface and/or the back surface of the spectacle lens. The first coating composition may be applied for example by dip coating, spin coating, or inkjet printing, typically spin coating. The definition of “selectively curing” as well as for “applied to fully cover,” both given before, shall apply.

The second coating composition may be applied for example by dip coating, spin coating, or inkjet printing, typically spin coating or dip coating, typically to fully cover the first surface layer resulting from selectively curing the first coating composition and a front surface comprising the first surface layer; and/or typically to fully cover the first surface layer resulting from selectively curing the first coating composition and a back surface comprising the first surface layer. An optional third coating composition and each optional further coating composition may be applied for example by dip coating, spin coating, or ink jet printing, typically to fully cover the second surface layer resulting from the second coating composition. An optional third surface layer or an optional further surface layer may result from a third optional or further optional coating composition applied for example by dip coating, spin coating, or inkjet printing, typically spin coating or dip coating, or may comprise a layer stack applied via physical vapour deposition, each to cover a respective surface layer underneath typically fully.

The first coating composition is
selectively cured to result, with respect to a selectively cured part of the first coating composition, in a first surface layer. The not cured part of the first coating composition may be removed.

The second coating composition is
selectively cured to result, with respect to a selectively cured part of the second coating composition, in a second surface layer. The not cured part of the second coating composition may be removed.

Typically, more surface layers of a coated spectacle lens forming or causing (i) one structure or (ii) a plurality of structures corresponding to (i) one predefined structure or (ii) a plurality of predefined structures of a digital twin of the coated spectacle lens require at least the manufacturing steps of
a) applying a first coating composition to fully cover a front surface and/or to fully cover a back surface of a spectacle lens, typically the front surface,
b) selectively curing the first coating composition using laser radiation or a laser beam by applying determined laser process parameters,
c) removing not cured first coating composition from the front surface and/or the back surface,
d) applying a second coating composition,
e) selectively curing the second coating composition using laser radiation or a laser beam by applying determined laser process parameters,
f) removing not cured second coating composition.

The selectively cured first coating composition of step b) forms a first surface layer of a coated spectacle lens. Even though the not cured coating composition is removed in step c) and thus the first surface layer resulting in step b) is not completely covering the front surface and/or the back surface of the spectacle lens, as the case may have been when applying the first coating composition in step a), the selectively cured first coating composition shall be regarded as first surface layer. As the not cured first coating composition is removed in step c) the second coating composition is applied to the first surface layer and the front surface and/or the back surface comprising the first surface layer. A second coating composition may also be applied to a front surface or back surface of a spectacle lens not comprising the first surface layer. Typically, the second coating composition is applied to completely cover the front surface and/or the back surface comprising the first surface layer and optionally to completely cover a front surface or a back surface not comprising the first surface layer. The second coating composition may be selectively cured in a same position or in a same domain as the first coating composition had been selectively cured or the second coating composition may be selectively cured in a different position or in a different domain as the first coating composition had been selectively cured, each resulting in a second surface layer. The first surface layer and the second surface layer together are forming or causing (i) one structure or (ii) a plurality of structures corresponding to (i) one predefined structure or (ii) a plurality of predefined structures of a digital twin of the coated spectacle lens.

The first coating composition and the second composition may be composed of a same coating composition. Typically, the same coating composition comprises identical chemical ingredients, either in identical amounts or in different amounts. Reference is made to the before detailed description of a first and second coating composition.

Even if a first surface layer resulting from the first coating composition and a second surface layer resulting from the second coating composition may differ, as mentioned before, in a position or in positions, or in a domain or in domains, the first and second surface layer together are forming or causing (i) the one structure or the (ii) plurality of structures of the coated spectacle lens.

An optional third coating composition typically is composed of a different coating composition to the same first and second coating compositions. A resulting third surface layer typically covers the second surface layer and a lens surface of a spectacle lens, i.e., a front surface or a back surface of the spectacle lens, comprising the first and the second surface layers.

The first and second surface layer are typically provided anyway in the coated spectacle lens for the additional benefits outlined above. At least one of the first and second surface layer may be an additional surface layer not provided anyway in the coated spectacle lens.

The laser process parameters power and energy summarized and defined in section 3.13 of ISO 11145:2018(E), in particular the laser process parameter peak power as defined in section 3.13.9 of ISO 11145:2018(E), typically is/are determined such that
a coating composition, e.g., in before described case when (i) one structure or (ii) a plurality of structures is/are formed or caused by one surface layer, or
a first coating composition, e.g., in before described case when (i) one structure or (ii) a plurality of structures is/are formed or caused by more surface layers,
a first and second coating composition, e.g., in before described case when (i) one structure or (ii) a plurality of structures is/are formed or caused by more surface layers,
a first and third coating composition, e.g., in before described case when (i) one structure or (ii) a plurality of structures is/are formed or caused by more surface layers,
   is selectively cured or selectively precured.

In particular the laser process parameter peak power as defined in ISO 11145:2018(E), section 3.13.9, is determined such that (i) one predefined structure or (ii) a plurality of predefined structures of a digital twin of a coated spectacle lens, when transferred to physical reality, correspond to (i) one structure or (ii) a plurality of structures of a respective coated spectacle lens. The coating composition or the first coating composition, each applied to fully cover a front surface and/or a back surface of a spectacle lens, the first and second coating compositions, the first and third coating compositions, each applied as described before, is/are selectively cured or selectively precured using laser radiation or a laser beam typically with a predetermined peak power.

The following considerations for a determination of the laser parameter peak power are exemplarily
with respect to the one coating composition or the first coating composition, each thereof composed of a same coating composition, each applied to fully cover a front surface and/or a back surface of a spectacle lens in a same thickness, whereby the front surface and/or the back surface to which the coating composition or the first coating composition is applied to is of a same lens surface,
considering a step of removing not cured one coating composition or not cured first coating composition,
considering discrete x,y,z positions of the front surface or the back surface of the spectacle lens which comprises the one coating composition or the first coating composition, a pattern of x,y positions typically being adapted or selected to consider a beam diameter. in particular a beam diameter dᵤ(z), of a laser,
considering discrete x,y,z positions of the front surface and the back surface of the spectacle lens both comprising the one coating composition or the first coating composition, pattern of x,y positions typically being adapted or selected to consider a beam diameter, in particular a beam diameter dᵤ(z), of a laser, and a unique orientation of both patterns relative to each other:
   A) for selectively curing the one coating composition the peak power typically is selected such that each z position of one resulting surface layer forming or causing (i) one structure or (ii) a plurality of structures corresponds in each discrete x,y position to a respective discrete z position of a respective digital twin of a coated spectacle lens. Therefore, an actual value of a height of (i) one structure or (ii) a plurality of structures formed by the one surface layer corresponds in each position to a respective target value for the height. An actual value of a layer thickness of the one surface layer causing (i) one structure or (ii) a plurality of structures corresponds in each position to a respective target value for the layer thickness. A variation of the laser process parameter peak power for selectively curing the one coating composition typically causes no loss in height or layer thickness of the resulting one surface layer while removing not cured coating composition;
   B) for selectively precuring the one coating composition the peak power typically is selected such that each z position of one resulting surface layer forming or causing (i) one structure or (ii) a plurality of structures corresponds in each discrete x,y position to a respective discrete z position of a respective digital twin of a coated spectacle lens. Therefore, an actual value of a height of (i) one structure or (ii) a plurality of structures formed by the one surface layer corresponds in each position to a respective target value for the height. An actual value of a layer thickness of the one surface layer causing (i) one structure or (ii) a plurality of structures corresponds in each position to a respective target value for the layer thickness. Selectively precuring the coating composition may cause a loss in height or in layer thickness of the resulting surface layer while removing not cured coating composition. The loss is typically considered;
   C) for selectively curing the first coating composition the peak power typically is selected such that a resulting first surface layer and a second surface layer, as explained before, together form or cause (i) one structure or (ii) a plurality of structures, and each z position of the first and second surface layer corresponds in each discrete x,y position to a respective discrete z position of a respective digital twin of a coated spectacle lens. Therefore, an actual value of a height of (i) one structure or (ii) a plurality of structures formed by the first and second coating composition corresponds in each position to a respective target value for the height. An actual value for a layer thickness of the first surface layer and the second surface layer together forming (i) one structure or (ii) a plurality of structures corresponds in each position to a target value of the layer thickness. With respect to a height or layer thickness of the first surface layer, selectively curing a first coating composition typically causes no loss in height or layer thickness while removing not cured first coating composition;
   D) for selectively precuring the first coating composition the peak power typically is selected such that a resulting first surface layer and a second surface layer, as explained before, together form or cause (i) one structure or (ii) a plurality of structures, and each z position of the first and second surface layer corresponds in each discrete x,y position to a respective discrete z position of a respective digital twin of a coated spectacle lens. Therefore, an actual value of a height of (i) one structure or (ii) a plurality of structures formed by the first and second coating composition corresponds in each position to a respective target value for the height. An actual value for a layer thickness of the first surface layer and the second surface layer together forming (i) one structure or (ii) a plurality of structures corresponds in each position to a target value of the layer thickness. With respect to a height or layer thickness of the first surface layer, selectively precuring a first coating composition may cause a loss in height or layer thickness while removing not cured first coating composition. The loss is typically considered.

Summarising, the laser parameter peak power mainly affects a curing level of the one coating composition or the first coating composition and hence, after removing not cured one coating composition or first coating composition, a height or layer thickness of a resulting surface layer or first surface layer. The lower the peak power is the lower the curing level is and thus the higher a loss in height or layer thickness is in one resulting surface layer or first surface layer after removing not cured one coating composition or first coating composition.

When determining laser process parameters to achieve (i) one predefined structure or (ii) a plurality of predefined structures of a digital twin of a coated spectacle lens, it is typically considered that while applying the determined laser process parameters to a coating composition, laser process parameters may influence each other. For example, for a setting of the before described laser process parameter peak power the laser process parameter scan speed typically is considered. The higher the peak power shall be determined, the higher the scan speed may be, the lower the peak power shall be, the lower the scan speed may be for obtaining a same curing level.

The laser parameter pulse repetition rate as defined in ISO 11145:2018(E), section 3.14.3, typically is determined such that
one coating composition, e.g., in before described case when (i) one structure or (ii) a plurality of structures is/are formed or caused by one surface layer, or
a first coating composition, e.g., in before described case when (i) one structure or (ii) a plurality of structures is/are formed or caused by more surface layers,
a first and second coating composition, e.g., in before described case when (i) one structure or (ii) a plurality of structures is/are formed or caused by more surface layers,
a first and third coating composition, e.g., in before described case when (i) one structure or (ii) a plurality of structures is/are formed or caused by more surface layers, is/are selectively cured or selectively precured.

The (i) one structure or (ii) the plurality of structures correspond to (i) one predefined structure or (ii) a plurality of predefined structures of a respective digital twin of a coated spectacle lens. The one coating composition or the first coating composition, each applied to fully cover a front surface and/or a back surface of a spectacle lens, the first and second coating compositions, the first and third coating compositions, each applied as described before, is/are selectively cured or selectively precured using laser radiation or a laser beam typically in a predetermined pulse repetition rate.

The following considerations for a determination of the laser parameter pulse repetition rate are exemplarily
with respect to the one coating composition or the first coating composition, each thereof composed of a same coating composition, each applied to fully cover a front surface and/or a back surface of a spectacle lens in a same thickness, whereby the front surface and/or the back surface to which the one coating composition or the first coating composition is applied to is of a same lens surface,
considering a step of removing not cured one coating composition or not cured first coating composition
considering discrete x,y,z positions of the front surface or the back surface of the spectacle lens which comprises the one coating composition or the first coating composition, a pattern of x,y positions typically being adapted or selected to consider a beam diameter, in particular a beam diameter dᵤ(z), of a laser,
considering discrete x,y,z positions of the front surface and the back surface of the spectacle lens both comprising the one coating composition or the first coating composition, a pattern of x,y positions typically being adapted or selected to consider a beam diameter, in particular a beam diameter dᵤ(z), of a laser, and a unique orientation of both patterns relative to each other:
   (A) a pulse repetition rate is determined such that one coating composition is selectively cured or selectively precured and such that a surface of one resulting surface layer forming or causing (i) one structure or (ii) a plurality of structures corresponds to (i) one predefined structure or (ii) a plurality of predefined structures of a respective digital twin of a coated spectacle lens;
   (B) a pulse repetition rate is determined such that a first coating composition is selectively cured or selectively precured and such that a resulting first surface layer together with a second surface layer form or cause (i) one structure or (ii) a plurality of structures whose surface(s) correspond to a surface of (i) one predefined structure or to surfaces of each of (ii) a plurality of predefined structures of a respective digital twin of a coated spectacle lens.

Summarising, the laser parameter pulse repetition rate mainly affects a curing level of the one coating composition or the first coating composition and hence, after removing not cured one coating composition or first coating composition, a height or layer thickness of a resulting surface layer or first surface layer. The higher the pulse repetition rate the less the curing level of the coating composition is.

In an exemplary embodiment of the disclosure, the manufacturing comprises the step of
applying determined laser process parameters such as at least one of
   a spatial variation in z direction in the setting of the one laser process parameter or the more laser process parameters,
   the spatial variation in x,y direction in the setting of the one laser process parameter or the more laser process parameters,
      achieves (i) one structure or a (ii) plurality of structures or (iii) a same structure out of the plurality of structures.

A surface normal at either an apex of a front surface of a spectacle lens or an apex of a back surface of a spectacle lens shall define an origin of an x,y,z coordinate system and a “z direction.”

An “x,y direction” shall be in a tangential plane to either the front surface at the apex or the back surface at the apex. An x direction and a y direction shall be perpendicular to each other in the tangential plane.

Instead of the surface normal at the apex of the front surface or instead of the surface normal at the apex of the back surface an optical center of the spectacle lens may define an origin of the x,y,z coordinate system and a surface normal at the optical center may define a z direction. The optical center of a spectacle lens is as defined in ISO 13666:2019(E), section 3.2.15, an intersection of the optical axis (3.1.8) with the front surface (3.2.13) of a lens (3.5.2). The x,y direction then is in the tangential plane to the intersection with the front surface. In the tangential plane the x direction and the z direction are perpendicular to each other.

In case a front surface or a back surface of a spectacle lens is for example a power-variation surface or another surface without an unambiguously definably apex, typically a surface normal at a fitting point of the spectacle lens shall define the origin of the x,y,z coordinate system and a primary direction may define a z direction. The fitting point of a spectacle lens is as defined in ISO 13666:2019(E), section 3.2.34, a point on the front surface (3.2.13) of a lens (3.5.2) or blank (3.8.1) stipulated by the manufacturer for positioning the lens in front of the eye. The primary direction of a spectacle lens is as defined in ISO 13666:2019(E), section 3.2.25, a direction of the line of sight (3.2.24), usually taken to be the horizontal, to an object at an infinite distance measured with habitual head and body posture when looking straight ahead in unaided vision. In that case, the x,y direction is in the plane perpendicular to the primary direction. In the plane perpendicular to the primary direction the x direction and the y direction are perpendicular to each other.

The before given explanations, in particular with respect to the spatial variation, shall apply accordingly.

In an exemplary embodiment of the disclosure, the manufacturing comprises the step of
applying determined laser process parameters such as to stepwise achieve at least one of
   a. (i) one structure,
   b. a (ii) plurality of structures,
   c. a (iii) same structure out of the plurality of structures.

The before given explanations, in particular with respect to “stepwise,” shall apply accordingly.

In an exemplary embodiment of the disclosure, the manufacturing comprises the step of
applying the determined laser process parameters such as to achieve a surface power of at least one of
   a. (i) one structure,
   b. each structure of a (ii) plurality of structures,
   c. a (iii) same structure out of the plurality of structures,
      which is different to a surface power of a lens surface
         comprising at least one of the (i) one structure, the (ii) plurality of structures and the (iii) same structure out of the plurality of structures,
         outside a position or a domain occupied by the at least one of the (i) one structure, the (ii) plurality of structures and the (iii) same structure out of the plurality of structures,
      within at least one of the following ranges:
         A. the difference in surface power being within a range of 0.25 dioptres to 50 dioptres;
         B. the difference in surface power being within a range of 1 dioptre to 25 dioptres;
         C. the difference in surface power being within a range of 2 dioptres to 20 dioptres;
         D. the difference in surface power being within a range of 5 dioptres to 12 dioptres.

The before given definitions, in particular with respect to the surface power, shall apply accordingly.

In an exemplary embodiment of the disclosure, the manufacturing comprises the step of
applying determined laser process parameters such as to achieve a secondary structure along a respective surface of at least one of
   a. (i) one structure,
   b. each structure of a (ii) plurality of structures,
   c. a (iii) same structure out of the plurality of structures.

The secondary structure may modify a surface, typically in the sense of surface shape, form, or topography, selected or pieced together from at least one of the before, with respect to (i) one structure or a (ii) plurality of structures, mentioned surfaces.

The secondary structure may be periodic or non-periodic.

The secondary structure may cause that a surface of at least one of the (i) one structure, each structure of a (ii) plurality of structures, a (iii) same structure out of the plurality of structures, deviates from a, with respect to a digital twin of a coated spectacle lens, predefined surface. The surface deviation may be in a direction perpendicular to a tangential plane in a discrete x,y,z position in a range of 5 nm to one tenth of a domain of one structure or in a range of 5 nm to 1 one tenth of a maximum z position of one structure.

In a further exemplary embodiment of the disclosure, the method comprises a measurement and calculation step. The measurement step comprises measurement of a coated spectacle lens or a part of a coated spectacle comprising (i) one structure or a (ii) plurality of structures by white light interferometry.

The method is characterized in the steps of
determining discrete z positions along one straight line along one x,y direction of at least one of
   i) one structure,
   each structure of a (ii) plurality of structures and
   a (iii) same structure out of the plurality of structures,
      each having a spherical target curvature along the one straight line along the x,y direction,
determining from these discrete z positions a slope at each discrete x,y position along the one x,y direction, wherein a change of the slope along the one x,y direction deviates from a linear change of a slope of the target spherical curvature.

A spherical target curvature typically shall define a curvature being spherical along one straight line along one x,y direction of a surface selected or pieced together from the before mentioned ones.

The deviation from a linear change of a slope of the target spherical curvature is an indication for a secondary structure along a surface of at least one of the (i) one structure, each structure of the (ii) plurality of structures and the (iii) same structure out of the plurality of structures. This indication might be useful in case a resolution of a measuring device is not sufficient to reveal secondary structures.

In an exemplary embodiment of the disclosure, the manufacturing comprises the step of
applying (a) one additional coating composition or (b) more additional coating compositions to (i) one structure or a (ii) plurality of structures.

In case one additional coating composition or the more additional coating result in a second surface layer, a third surface layer, a fourth surface layer or a further surface layer, reference is made to the before given explanations. At least one additional coating layer resulting from the one additional coating composition or the more additional coating compositions typically is selected from the group consisting of a hard coating surface layer, hard coating as defined in ISO 13666:2019(E), section 3.18.2; an anti-reflective coating surface layer, anti-reflective coating as defined in ISO 13666:2019(E), section 3.18.3; a clean coating surface layer, clean coating as defined in ISO 13666:2019(E), section 3.18.4; a hydrophobic coating surface layer, hydrophobic coating as defined on ISO 13666:2019(E), section 3.18.5; a hydrophilic coating surface layer, hydrophilic coating as defined in ISO 13666:2019(E), section 3.18.6; an anti-fog coating surface layer, anti-fog coating as defined in ISO 13666:2019(E), section 3.18.7; an anti-static coating surface layer, anti-static coating as defined in ISO 13666:2019(E), section 3.18.8.

In an exemplary embodiment of the disclosure, the manufacturing comprises the step of
applying the determined laser process parameters, considering (a) one additional coating composition or (b) more additional coating compositions, such as to achieve a surface power of at least one of
   a. (i) one structure,
   b. each structure of a (ii) plurality of structures,
   c. a (iii) same structure out of the plurality of structures,
      which is different to a surface power of a lens surface
         comprising the (i) one structure, the (ii) plurality of structures, the (iii) same structure out of the plurality of structures,
         outside a position or a domain occupied by the at least one of the (i) one structure, the (ii) plurality of structures and the (iii) same structure out of the plurality of structures,
      within at least one of the following ranges:
         A. the difference in surface power being within a range of 0.25 dioptres to 25 dioptres;
         B. the difference in surface power being within a range of 1 dioptre to 25 dioptres;
         C. the difference in surface power being within a range of 2 dioptres to 20 dioptres;
         D. the difference in surface power being within a range of 5 dioptres to 12 dioptres.

The before provided definitions and explanations shall apply accordingly.

The method for manufacturing a coated spectacle lens, one surface layer or more surface layers comprising (i) one structure or (ii) a plurality of structures, the method is characterized in the step of
selectively curing one coating composition or more coating compositions on a surface of a spectacle lens, using laser radiation, the laser radiation as defined in ISO 11145:2018(E), section 3.19.4, or a laser beam, the laser beam as defined in ISO 11145:2018(E), section 3.19.5, to result in the one surface layer or the more surface layers on the surface of the spectacle lens, the one surface layer or the more surface layers comprising the (i) one structure or the (ii) plurality of structures.

Typically, the method for manufacturing a coated spectacle lens, one surface layer or more surface layers comprising (i) one structure or (ii) a plurality of structures, the method is characterized in that the one coating composition or the more the coating compositions is/are fully covering the surface of the spectacle lens.

Typically, the method for manufacturing a coated spectacle lens, one surface layer or more surface layers comprising (i) one structure or (ii) a plurality of structures, the method is characterized in the step of
removing not cured coating composition(s) from the surface of the spectacle lens.

Typically, the method for manufacturing a coated spectacle lens, one surface layer or more surface layers comprising (i) one structure or (ii) a plurality of structures, the method is characterized in that the one surface layer or the more surface layers is/are forming or causing the (i) one structure or the (ii) plurality of structures.

Typically, the method for manufacturing a coated spectacle lens, one surface layer or more surface layers comprising (i) one structure or (ii) a plurality of structures, the method is characterized in that the laser radiation or the laser beam is applied according to laser process parameters such as at least one of
a spatial variation in z direction in a setting of one laser process parameter or more laser process parameters,
a spatial variation in x,y direction in a setting of one laser process parameter or more laser process parameters,
   achieves the (i) one structure or the (ii) plurality of structures or (iii) a same structure out of the plurality of structures.

Typically, the method for manufacturing a coated spectacle lens, one surface layer or more surface layers comprising (i) one structure or (ii) a plurality of structures, the method is characterized in that the laser process parameters are applied stepwise to achieve at least one of
a. the (i) one structure,
b. the (ii) plurality of structures,
c. the (iii) same structure out of the plurality of structures.

Typically, the method for manufacturing a coated spectacle lens, one surface layer or more surface layers comprising (i) one structure or (ii) a plurality of structures, the method is characterized in that the laser process parameters are applied such as to achieve a surface power of at least one of
a. the (i) one structure,
b. each structure of the (ii) plurality of structures,
c. the (iii) same structure out of the plurality of structures,
   which is different to a surface power of a lens surface
      comprising at least one of the (i) one structure, the (ii) plurality of structures and the (iii) same structure out of the plurality of structures,
      outside a position or a domain occupied by the at least one of the (i) one structure, the (ii) plurality of structures and the (iii) same structure out of the plurality of structures,
   within at least one of the following ranges:
      A. the difference in surface power being within a range of 0.25 dioptres to 50 dioptres;
      B. the difference in surface power being within a range of 1 dioptre to 25 dioptres;
      C. the difference in surface power being within a range of 2 dioptres to 20 dioptres;
      D. the difference in surface power being within a range of 5 dioptres to 12 dioptres.

Typically, the method for manufacturing a coated spectacle lens, one surface layer or more surface layers comprising (i) one structure or (ii) a plurality of structures, the method is characterized in that the laser process parameters are applied such as to achieve a secondary structure along a respective surface of at least one of
a. the (i) one structure,
b. each structure of the (ii) plurality of structures,
c. the (iii) same structure out of the plurality of structures.

Typically, the method for manufacturing a coated spectacle lens, one surface layer or more surface layers comprising (i) one structure or (ii) a plurality of structures, the method is characterized in the steps of
determining discrete z positions along one straight line along one x,y direction of at least one of
   the (i) one structure,
   each structure of the (ii) plurality of structures and
   the (iii) same structure out of the plurality of structures,
      each having a spherical target curvature along the one straight line along the x,y direction,
determining from these discrete z positions a slope at each discrete x,y position along the one x,y direction, wherein a change of the slope along the one x,y direction deviates from a linear change of a slope of the target spherical curvature.

Typically, the method for manufacturing a coated spectacle lens, one surface layer or more surface layers comprising (i) one structure or (ii) a plurality of structures, the method is characterized in that the manufacturing comprises the step of
applying (a) one additional coating composition or (b) more additional coating compositions.

Typically, the method for manufacturing a coated spectacle lens, one surface layer or more surface layers comprising (i) one structure or (ii) a plurality of structures, the method is characterized in that the manufacturing comprises the step of
applying the determined laser process parameters such as to achieve a surface power of at least one of
   a. the (i) one structure,
   b. each structure of the (ii) plurality of structures,
   c. the (iii) same structure out of the plurality of structures,
      which is different to a surface power of a lens surface
comprising the (i) one structure, the (ii) plurality of structures, the (iii) same structure out of the plurality of structures,
outside a position or a domain occupied by the at least one of the (i) one structure, the (ii) plurality of structures and the (iii) same structure out of the plurality of structures,
   within at least one of the following ranges:
A. the difference in surface power being within a range of 0.25 dioptres to 25 dioptres;
B. the difference in surface power being within a range of 1 dioptre to 25 dioptres;
C. the difference in surface power being within a range of 2 dioptres to 20 dioptres;
D. the difference in surface power being within a range of 5 dioptres to 12 dioptres.

With respect to the method for manufacturing a coated spectacle lens and with respect to the preferable embodiment of the method for manufacturing a coated spectacle lens, before provided definitions and explanations shall apply accordingly.

A computer according to the disclosure is configured to perform the step of
determining laser process parameters to achieve (i) one predefined structure or (ii) a plurality of predefined structures of a digital twin of a coated lens,
   and at least one selected from the group consisting of a laser as defined in ISO 11145:2018(E), section 3.19.1, a laser device as defined in ISO 11145:2018(E), section 3.19.6, a laser assembly as defined in ISO 11145:2018(E), section 3.19.7 and a laser unit as defined in ISO 11145:2018(E), section 3.19.8.

In an exemplary embodiment of the disclosure, a computer comprising a processor is configured to perform the before described method configured for designing a digital twin of a spectacle lens for the purpose of manufacturing the spectacle lens.

In an exemplary embodiment of the disclosure, a data processing system comprises a processor and a storage medium coupled to the processor, wherein the processor is adapted to perform the before described method configured for designing a digital twin of a spectacle lens for the purpose of manufacturing the spectacle lens based on a computer program stored on the storage medium. The computer program may be stored on a non-transitory tangible computer-readable storage medium, the computer program comprising instructions which, when the program is executed by a computer, cause the computer to carry out the method configured for designing a digital twin of a spectacle lens for the purpose of manufacturing the spectacle lens described before.

In an exemplary embodiment of the disclosure, a computer program comprises instructions which, when the program is executed by a computer, cause the computer to carry out the before described method configured for designing a digital twin of a spectacle lens for the purpose of manufacturing the spectacle lens.

The computer program may be stored on a non-transitory tangible computer-readable storage medium, the computer program comprising instructions which, when the program is executed by a computer, cause the computer to carry out the above-described method configured for designing a digital twin of a spectacle lens for the purpose of manufacturing the spectacle lens.

In an exemplary embodiment of the disclosure, a computer-readable storage medium having stored thereon the computer program. The computer-readable storage medium may be a non-transitory tangible computer-readable storage medium.

In an exemplary embodiment of the disclosure, a computer-readable medium comprises instructions which, when executed by a computer, cause the computer to carry out the before described method configured for designing a digital twin of a spectacle lens for the purpose of manufacturing the spectacle lens. The computer-readable storage medium may be a non-transitory tangible computer-readable storage medium.

In an exemplary embodiment of the disclosure, a computer-readable data carrier having stored thereon the before mentioned computer program.

In an exemplary embodiment of the disclosure, a data signal is carrying the before mentioned computer program.

The disclosure is described in the following at hands of examples not limiting the scope of the disclosure:

The coated spectacle lenses presented in the following part were prepared with a 3-axis UV marker laser (KEYENCE), with a laser radiation wavelength of 355 nm, a laser beam diameter of 25 μm, and a laser peak power at 100% 2.5 watt.

The UV curable coating composition deposited on top of a lens surface of a spectacle lens is based on pentaerythritol tetra acrylate (99 wt. %, Sigma Aldrich) and triaryl sulfonium hexafluorophosphate (1 wt. %, Sigma Aldrich). To achieve a desired thickness, 1-methoxy-2-proponal (30 wt. % in final coating composition) was added and formed as a homogeneous mixture.

The selective curing of the coating composition followed predefined structures designed by the laser integrated Logo designer. A co-central multiple ring-shaped structure with a ring-ring distance of 1 mm, and varied ring widths were designed. On the same lens surface deposited with coating composition, one or more designed structures can be used to generate desired structures for surface power.

The procedure for the selective curing is:
1) Clean or activate a lens substrate with or without a coating (Rx lens or semi-finished blanks)
2) Deposit the coating composition via a spin-coating process, non-cured or only partially cured
3) Select a predefined structure to be achieved by selectively curing the coating composition
4) Set up laser process parameters, such as peak power, pulse repetition rate, and scan speed
5) selective cure the coating composition
6) If necessary, repeat 3) to 5) one or more times
7) Rinse lens substrate with organic solvents or aqueous water solutions

For the following samples, lens substrate CR39 (diameter 65 mm, refractive index 1.5) was cleaned in distilled water and dried with hot air. Then, the UV-curable coating composition was deposited on top of it via spin-coating at 3000 rpm/s for 30 s. After applying laser radiation, the lens substrate was rinsed with acetone for 30 seconds. The selectively cured surface layer was overcoated with a hard coating composition and further processed at 110° C. for 1 hour to cure the hard coating layer.

Characterizations of generated structures were performed via the white-light scattering microscope of Zygo Corporation, USA and surface profilometer (Surfcom 3DF, surface texture measuring Instrument, ACCRETECH, Japan).

Example 1: Based on the coating composition deposited lens surface, laser radiation was performed on wet lens surface twice continuously (without moving lens substrate, processing time 180 seconds): first run following a multiple ring-shaped structure of 0.35 mm width, with laser process parameters of peak power 100%, pulse repetition rate of 200 kHz, scan speed of 500 mm/s, while the second run following the same multiple ring-shaped structure of 0.35 mm width, with laser process parameters of peak power 100%, pulse repetition rate of 40 kHz, scan speed of 500 mm/s.

Example 2: Based on the coating composition deposited lens surface, laser radiation was performed on wet lens surface twice continuously (without moving lens substrate): first run following a multiple ring-shaped pattern of 0.35 mm width, with laser process parameters of peak power 100%, pulse repetition rate of 200 kHz, scan speed of 500 mm/s, while the second run following the same multiple ring-shaped structure of 0.35 mm width, with laser process parameters of peak power 75%, pulse repetition rate of 40 kHz, scan speed of 500 mm/s.

Example 3: Based on the coating composition deposited lens surface, laser radiation was performed on wet lens surface twice continuously (without moving lens substrate): first run following a multiple ring-shaped structure of 0.35 mm width, with laser process parameters of peak power 100%, pulse repetition rate of 400 kHz, scan speed of 500 mm/s, while the second run following the same multiple ring-shaped structure of 0.35 mm width, with laser process parameters of peak power 100%, pulse repetition rate of 40 kHz, scan speed of 500 mm/s.

Example 4: Based on the coating composition deposited lens surface, laser radiation was performed on wet lens surface twice continuously (without moving lens substrate): first run following a multiple ring-shaped structure of 0.10 mm width, with laser process parameters of peak power 50%, pulse repetition rate of 400 kHz, scan speed of 500 mm/s, while the second run following the same multiple ring-shaped structure of 0.35 mm width, with laser process parameters of peak power 100%, pulse repetition rate of 40 kHz, scan speed of 500 mm/s.

Example 5: Based on the coating composition deposited lens surface, laser radiation was performed on wet lens surface three times continuously (without moving lens substrate): first run following a multiple ring-shaped structure of 0.20 mm width, with laser process parameters of peak power 100%, pulse repetition rate of 200 kHz, scan speed of 500 mm/s, while the second run following the same multiple ring-shaped structure of 0.35 mm width, with laser process parameters of peak power 50%, pulse repetition rate of 400 kHz, scan speed of 500 mm/s, and the third run following the same multiple ring-shaped structure of 0.35 mm width, with laser process parameters of peak power 100%, pulse repetition rate of 40 kHz, scan speed of 500 mm/s.

Example 6: Based on the coating composition deposited lens surface, laser radiation was performed on wet lens surface twice continuously (without moving lens substrate): first run following a multiple ring-shaped structure of 0.35 mm width, with laser process parameters of peak power 50%, pulse repetition rate of 400 kHz, scan speed of 500 mm/s, while the second run following the same multiple ring-shaped structure of 0.35 mm width, with laser process parameters of peak power 100%, pulse repetition rate of 40 kHz, scan speed of 500 mm/s.

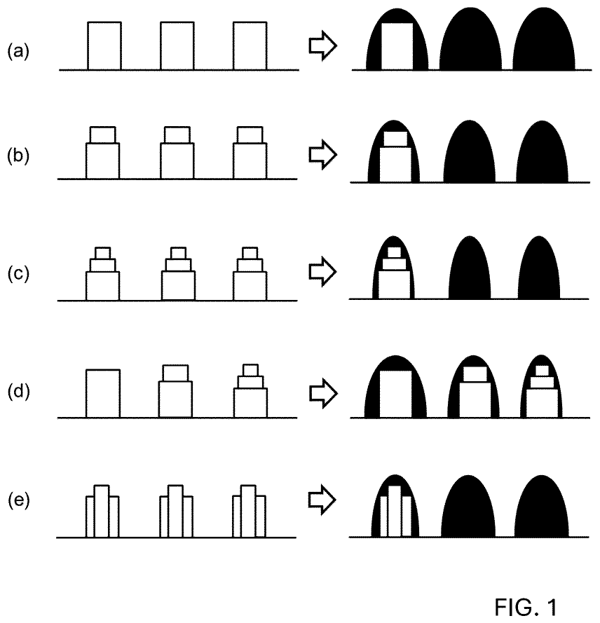

FIG. 1 schematically shows different structures obtained by a selectively cured a first surface layer (left hand side of (a) to (e)), overcoated with a second surface layer (right hand side of (a) to (e) on a lens surface.

FIG. 2 shows a surface profile (a) of the coated spectacle lens of examples 1 and a surface profile (b) of the coated spectacle lens of example 2, each before the application and curing of the hard coating. The surfaces profiles of the structures are rather flat with little curvature

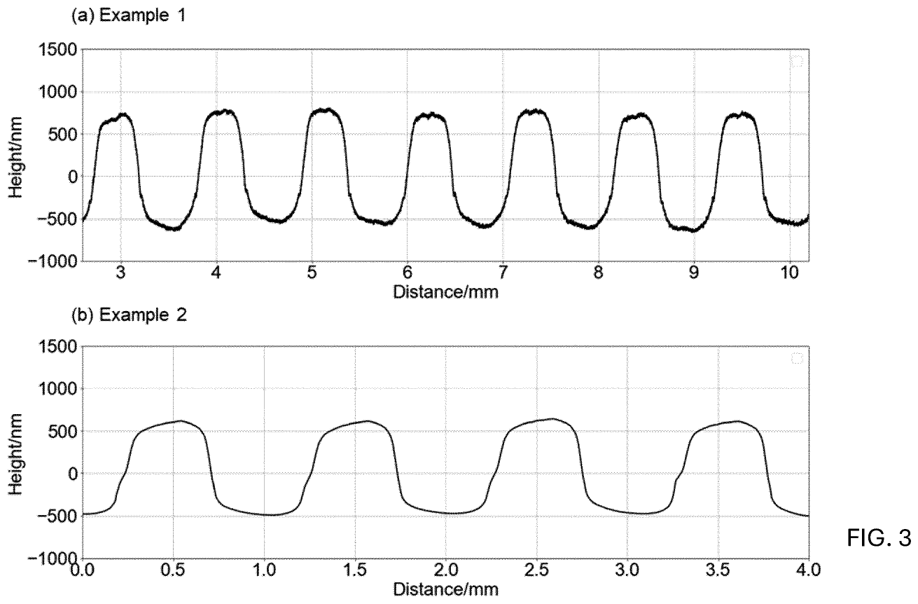

FIG. 3 shows the surface profile (a) of the coated spectacle lens of example 1 and a surface profile (b) of the coated spectacle lens of example 2, each with the hard coating surface layer. The surface profiles of the structures are smoothed and rounded, with a certain curvature.

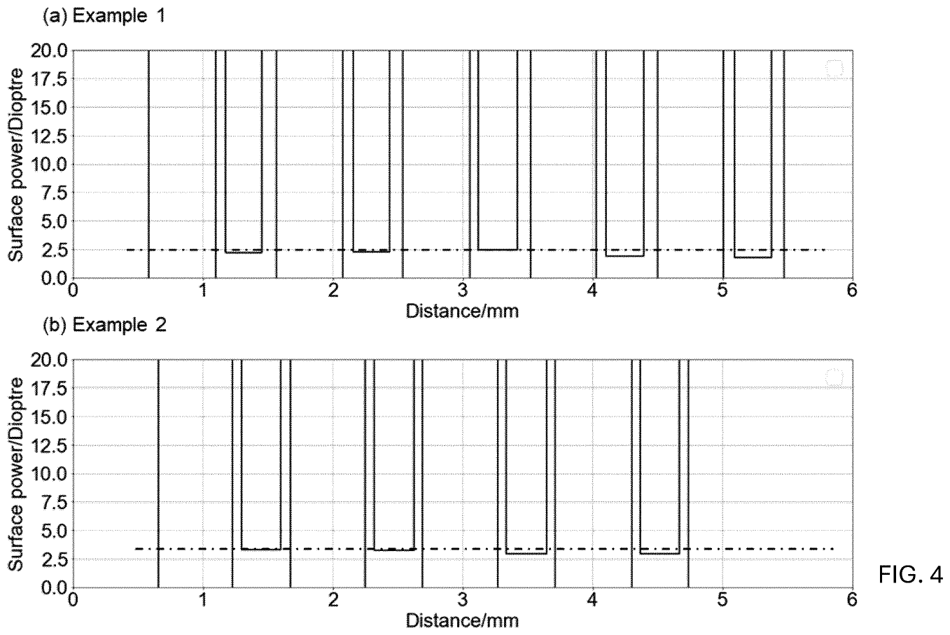

FIG. 4 shows the simulated surface power of the structures of FIG. 3, for the coated spectacle lenses of example 1 and 2, each overcoated with a hard coating surface layer. The surface power is calculated from the slope of surface curvature (with hard coating surface layer). Both show a surface power of 2-3 dioptre.

FIG. 5 shows the surface profile (a) of the coated spectacle lens of example 3 and (b) of the coated spectacle lens of example 4. With respect to the surface profiles of FIG. 1, the surfaces profiles changed from flat to staircase.

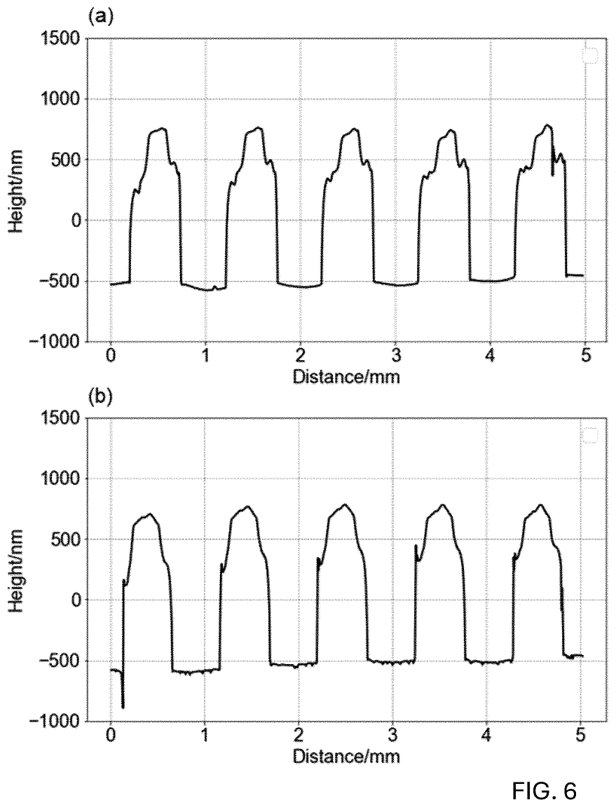

FIG. 6 shows the surface profile (a) of the coated spectacle lens of example 4 and (b) of the coated spectacle lens of example 5.

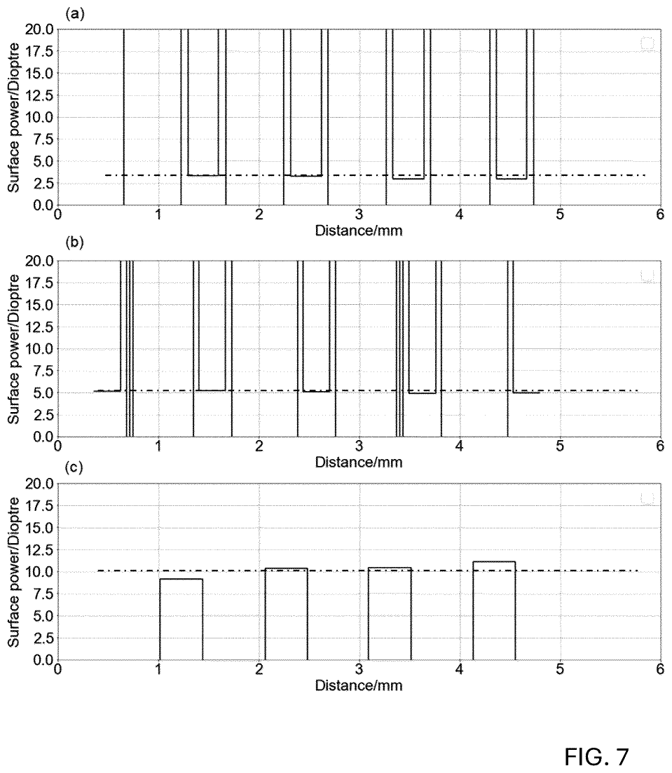

FIG. 7 shows the simulated surface power of the structures. The surface power is calculated from the slope of surface curvature (with hard coating surface layer). The surface power increased from (a) with 2.5 dioptres (coated spectacle lens of example 2), to (b) with 5 dioptres (coated spectacle lens of example 6), to (c) with 10 dioptres (coated spectacle lens of example 5).

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of.” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

1. A method being configured for designing a digital twin of a coated spectacle lens by means of a computer for the purpose of a use of the digital twin for manufacturing the coated spectacle lens, the digital twin of the coated spectacle lens comprising:
(i) one predefined structure; or
(ii) a plurality of predefined structures,
the digital twin of the coated spectacle lens describing the coated spectacle lens being computer-readable data additionally containing manufacturing instructions considering laser process parameters to achieve the (i) one predefined structure or (ii) the plurality of predefined structures,
a structure of the digital twin of the coated spectacle lens being a domain on a lens surface of the digital twin of the coated spectacle lens, the domain being part of one surface layer or more surface layers digitally added to a front surface and/or a back surface of a digital twin of a spectacle lens, or
a structure of the digital twin of the coated spectacle lens being a domain of a lens surface of the digital twin of the coated spectacle lens, the domain being caused by one surface layer or more surface layers digitally added to a front surface and/or a back surface of a digital twin of a spectacle lens,
the method comprising the step of:
determining the laser process parameters based on curing characteristics of a coating composition, a refractive index of a material of the structure being a uniform refractive index.

2. The method according to claim 1, the method further comprising:
determining the laser process parameters so as to comprise at least one of:
a spatial variation in a z direction of a setting of one laser process parameter or more laser process parameters,
a spatial variation in an x,y direction of a setting of one laser process parameter or more process laser parameters,
each to achieve the (i) one predefined structure or the (ii) plurality of predefined structures or (iii) a same predefined structure out of the plurality of predefined structures.

3. The method according to claim 1, the method further comprising:
revising laser process parameters by manufacturing the coated spectacle lens to confirm the laser process parameters, or
to redetermine laser process parameters based on curing characteristics to achieve the (i) one predefined structure or (ii) the plurality of predefined structures or the (iii) same predefined structure out of the plurality of predefined structures.

4. The method according to claim 1, the method further comprising:
determining the laser process parameters so as to stepwise achieve at least one of:
the (i) one predefined structure,
the (ii) plurality of predefined structures, or
the (iii) same predefined structure out of the plurality of predefined structures.

5. The method according to claim 1, the method comprising the step of manufacturing the coated spectacle lens based on the designed digital twin.

6. The method according to claim 5, wherein the manufacturing comprises the step of:
selectively curing the coating composition by applying the determined laser process parameters to achieve (i) one structure or (ii) a plurality of structures corresponding to the (i) one predefined structure or (ii) the plurality of predefined structures.

7. The method according to claim 6, wherein the manufacturing comprises the step of:
applying the determined laser process parameters such as at least one of:
the spatial variation in the z direction in the setting of the one laser process parameter or the more laser process parameters,
the spatial variation in the x,y direction in the setting of the one laser process parameter or the more laser process parameters,
achieves the (i) one structure or the (ii) plurality of structures or (iii) a same structure out of the plurality of structures.

8. The method according to claim 6, wherein the manufacturing comprises the step of:
applying the determined laser process parameters such as to stepwise achieve at least one of:
a. the (i) one structure,
b. the (ii) plurality of structures, or
c. the (iii) same structure out of the plurality of structures.

9. The method according to claim 6, wherein the manufacturing comprises the step of:
applying the determined laser process parameters such as to achieve a surface power of at least one of:
a. the (i) one structure,
b. each structure of the (ii) plurality of structures,
c. the (iii) same structure out of the plurality of structures,
which is different to a surface power of a lens surface
including at least one of the (i) one structure, the (ii) plurality of structures and the (iii) same structure out of the plurality of structures,
outside a position or a domain occupied by the at least one of the (i) one structure, the (ii) plurality of structures and the (iii) same structure out of the plurality of structures,
within at least one of the following ranges:
A. a difference in surface power being within a range of 0.25 dioptres to 50 dioptres;
B. the difference in surface power being within a range of 1 dioptre to 25 dioptres;
C. the difference in surface power being within a range of 2 dioptres to 20 dioptres;
D. the difference in surface power being within a range of 5 dioptres to 12 dioptres.

10. The method according to claim 6, wherein the manufacturing comprises the step of:
applying the determined laser process parameters so as to achieve a secondary structure along
a respective surface of at least one of:
a. the (i) one structure,
b. each structure of the (ii) plurality of structures, or
c. the (iii) same structure out of the plurality of structures.

11. The method according to claim 10, further comprising the steps of:
determining discrete z positions along one straight line along one x,y direction of at least one of:
the (i) one structure,
each structure of the (ii) plurality of structures and
the (iii) same structure out of the plurality of structures,
each having a spherical target curvature along the one straight line along the x,y direction,
determining from these discrete z positions a slope at each discrete x,y position along the one x,y direction, wherein a change of the slope along the one x,y direction deviates from a linear change of a slope of the target spherical curvature.

12. The method according to claim 6, wherein the manufacturing comprises the step of:
applying (a) one additional coating composition or (b) more additional coating compositions.

13. The method according to claim 12, wherein the manufacturing comprises the step of:
applying the determined laser process parameters such as to achieve a surface power of at least one of:
a. the (i) one structure,
b. each structure of the (ii) plurality of structures,
c. the (iii) same structure out of the plurality of structures,
which is different to a surface power of a lens surface comprising the (i) one structure, the (ii) plurality of structures, the (iii) same structure out of the plurality of structures,
outside a position or a domain occupied by the at least one of the (i) one structure, the (ii) plurality of structures and the (iii) same structure out of the plurality of structures,
within at least one of the following ranges:
A. a difference in surface power being within a range of 0.25 dioptres to 25 dioptres;
B. the difference in surface power being within a range of 1 dioptre to 25 dioptres;
C. the difference in surface power being within a range of 2 dioptres to 20 dioptres;
D. the difference in surface power being within a range of 5 dioptres to 12 dioptres.

14. A computer being configured to perform the step of:
determining laser process parameters to achieve (i) one predefined structure or (ii) a plurality of predefined structures of a digital twin of a coated lens,
a structure of the digital twin of the coated spectacle lens being a domain on a lens surface of the digital twin of the coated spectacle lens, the domain being part of one surface layer or more surface layers digitally added to a front surface and/or a back surface of a digital twin of a spectacle lens, or
a structure of the digital twin of the coated spectacle lens being a domain of a lens surface of the digital twin of the coated spectacle lens, the domain being caused by one surface layer or more surface layers digitally added to a front surface and/or a back surface of a digital twin of a spectacle lens,
a refractive index of a material of the structure being a uniform refractive index, and at least one selected from the group consisting of a laser as defined in ISO 11145:2018(E), section 3.19.1, a laser device as defined in ISO 11145:2018(E), section 3.19.6, a laser assembly as defined in ISO 11145:2018(E), section 3.19.7 and a laser unit as defined in ISO 11145:2018(E), section 3.19.8.

15. A computer program comprising instructions which, when the program is executed by a computer, cause the computer to carry out the method of claim 1.

16. A computer-readable storage medium having stored thereon the computer program of claim 15.

17. A method for manufacturing a coated spectacle lens, one surface layer or more surface layers containing (i) one structure or (ii) a plurality of structures, the method comprising the step of:
selectively curing one coating composition or more coating compositions on a surface of a spectacle lens, using laser radiation, the laser radiation as defined in ISO 11145:2018(E), section 3.19.4, or a laser beam, the laser beam as defined in ISO 11145:2018(E), section 3.19.5, to result in the one surface layer or the more surface layers on the surface of the spectacle lens, the one surface layer or the more surface layers comprising the (i) one structure or the (ii) plurality of structures, a refractive index of a material of a structure being a uniform refractive index.

18. The method according to claim 17, wherein the one coating composition or the more the coating compositions is/are fully covering the surface of the spectacle lens.

19. The method according to claim 17, further comprising the step of:
removing not cured coating composition(s) from the surface of the spectacle lens.

20. The method according to claim 17, wherein the one surface layer or the more surface layers is/are forming or causing the (i) one structure or the (ii) plurality of structures.

21. The method according to claim 17, wherein the laser radiation or the laser beam is applied according to laser process parameters such as at least one of:
a spatial variation in the z direction in a setting of one laser process parameter or more laser process parameters,
a spatial variation in the x,y direction in a setting of one laser process parameter or more laser process parameters,
achieves the (i) one structure or the (ii) plurality of structures or (iii) a same structure out of the plurality of structures.

22. The method according to claim 21, wherein the laser process parameters are applied stepwise to achieve at least one of:
a. the (i) one structure,
b. the (ii) plurality of structures,
c. the (iii) same structure out of the plurality of structures.

23. The method according to claim 17, wherein the laser process parameters are applied so as to achieve a surface power of at least one of:
a. the (i) one structure,
b. each structure of the (ii) plurality of structures,
c. the (iii) same structure out of the plurality of structures,
which is different to a surface power of a lens surface,
containing at least one of the (i) one structure, the (ii) plurality of structures and the (iii) same structure out of the plurality of structures,
outside a position or a domain occupied by the at least one of the (i) one structure, the (ii) plurality of structures and the (iii) same structure out of the plurality of structures,
within at least one of the following ranges:
A. a difference in surface power being within a range of 0.25 dioptres to 50 dioptres;
B. the difference in surface power being within a range of 1 dioptre to 25 dioptres;
C. the difference in surface power being within a range of 2 dioptres to 20 dioptres;
D. the difference in surface power being within a range of 5 dioptres to 12 dioptres.

24. The method according to claim 17, wherein the laser process parameters are applied such as to achieve a secondary structure along a respective surface of at least one of:
a. the (i) one structure,
b. each structure of the (ii) plurality of structures, or
c. the (iii) same structure out of the plurality of structures.

25. The method according to claim 24, further comprising the steps of:
determining discrete z positions along one straight line along one x,y direction of at least one of:
the (i) one structure,
each structure of the (ii) plurality of structures and
the (iii) same structure out of the plurality of structures,
each having a spherical target curvature along the one straight line along the x,y direction,
determining from these discrete z positions a slope at each discrete x,y position along the one x,y direction, wherein a change of the slope along the one x,y direction deviates from a linear change of a slope of the target spherical curvature.

26. The method according to claim 17, wherein the manufacturing comprises the step of:
applying (a) one additional coating composition or (b) more additional coating compositions.

27. The method according to claim 26, wherein the manufacturing comprises the step of:
applying the determined laser process parameters so as to achieve a surface power of at least one of:
a. the (i) one structure,
b. each structure of the (ii) plurality of structures,
c. the (iii) same structure out of the plurality of structures,
which is different to a surface power of a lens surface,
comprising the (i) one structure, the (ii) plurality of structures, the (iii) same structure out of the plurality of structures,
outside a position or a domain occupied by the at least one of the (i) one structure, the (ii) plurality of structures and the (iii) same structure out of the plurality of structures, within at least one of the following ranges:
A. a difference in surface power being within a range of 0.25 dioptres to 25 dioptres;
B. the difference in surface power being within a range of 1 dioptre to 25 dioptres;
C. the difference in surface power being within a range of 2 dioptres to 20 dioptres;
D. the difference in surface power being within a range of 5 dioptres to 12 dioptres.
